(19) United States
(12) Patent Application Publication
(10) Pub. No.: US 2007/0154591 A1
(43) Pub. Date: Jul. 5, 2007

(54) Chewing gum comprising biodegradable polymers and having accelerated degradability

(76) Inventor: Lone Andersen, Middelfart (DK)

Correspondence Address: CANTOR COLBURN, LLP, 55 GRIFFIN ROAD SOUTH, BLOOMFIELD, CT, 06002, US

(21) Appl. No.: 10/585,020

(22) PCT Filed: Dec. 30, 2003
(86) PCT No.: PCT/DK03/00939

§ 371 Date: Jan. 12, 2007

(51) Int. Cl. A23G 4/00

(52) U.S. Cl. 426/3

(57) ABSTRACT

The invention relates to chewing gum comprising at least one polymer, chewing gum ingredients and enzymes, wherein at least on of said polymers forms a substrate for at least one of said enzymes. According to the invention the degradation of chewing gum comprising a combination of biodegradable polymers and enzymes is accelerated compared to chewing gum without enzymes. By incorporation of enzymes it is possible to obtain a chewing gum, which is relatively fast degrading compared to chewing gum, which is exposed to normal environmental conditions only.

### FIELD OF THE INVENTION

The invention relates to a chewing gum comprising biodegradable polymers and having an accelerated degradability.

### BACKGROUND OF THE INVENTION

It is generally recognized that chewing gum that is dropped in indoor or outdoor environments gives rise to considerable nuisances and inconveniences due to the fact that the dropped gum sticks firmly to e.g. street and pavement surfaces and to shoes and clothes of people being present or moving in the environments. Adding substantially to such nuisances and inconveniences is the fact that currently available chewing gum products are based on the use of elastomeric and resinous polymers of natural or synthetic origin that are substantially non-degradable in the environment.

City authorities and others being responsible for cleanliness of indoor and outdoor environments therefore have to exercise considerable efforts to remove dropped chewing gum, such efforts, however, being both costly and without satisfactory results.

Attempts have been made to reduce the nuisances associated with the widespread use of chewing gum, e.g. by improving cleaning methods to make them more effective with regard to removal of dropped chewing gum remnants or by incorporating anti-sticking agents into chewing gum formulations. However, none of these precautions have contributed significantly to solving the pollution problem.

The past two decades have seen an increasing amount of interest paid to synthetic polyesters for a variety of applications ranging from biomedical devices to gum bases. Many of these polymers are readily hydrolyzed to their monomeric hydroxyacids, which are easily removed by metabolic pathways. Biodegradable polymers are e.g. anticipated as alternatives to traditional non- or low-degradable plastics such as poly(styrene), poly(isobutylene), and poly(methyl-methacrylate).

Thus, it has recently been disclosed, e.g. in U.S. Pat. No. 5,672,367, that chewing gum may be made from certain synthetic polymers having in their polymer chains chemically unstable bonds that can be broken under the influence of light or hydrolytically into water-soluble and non-toxic components. The claimed chewing gum comprises at least one degradable polyester polymer obtained by the polymerization of cyclic esters, e.g. based on lactides, glycolides, trimethylene carbonate and ε-caprolactone. It is mentioned in this patent application that chewing gum made from such polymers that are referred to as biodegradable are degradable in the environment.

A problem related to the prior art is, however, that even biodegradable chewing gum may under certain circumstances inherit unsatisfying degradability rates.

It is an object of the invention to obtain a chewing gum with even faster degradability than what is described in the prior art.

### SUMMARY OF THE INVENTION

The invention relates to chewing gum comprising at least one polymer, chewing gum ingredients and enzymes, wherein at least one of said polymers forms a substrate for at least one of said enzymes.

According to the invention chewing gum polymers forming enzyme substrates may be susceptible to enzymatic action in the sense that they contain chemical bonds, the cleavage of which may be catalyzed by enzymes. Therefore according to the invention the degradation of chewing gum comprising a combination of polymers and enzymes may be accelerated compared to the degradation of chewing gum without enzymes. By incorporation of enzymes it is possible to obtain a chewing gum, which is degrading relatively fast compared to chewing gum, which is exposed to normal environmental conditions only. The degradation according to the invention may lead to disintegration of the chewing gum into smaller lumps, oligomers, trimers, dimers and ultimately monomers and smaller products. Whether the extension of the degradation is partial or total depends on time elapsed, pH, moisture, temperature and further chemical, physical and environmental factors.

In an embodiment of the invention, said chewing gum includes center filling.

In manufacture of chewing gum according to the invention enzymes, may be incorporated in the center filling and consequently mixed into all parts of the chewing gum during the process of chewing, whereby the enzymatic catalyzing effect on degradation may be obtained. The enzymes incorporated may be added as e.g. liquid or powder or contained in encapsulation.

In an embodiment of the invention, said chewing gum includes coating.

Thus, enzymes may be incorporated in the coating of the chewing gum and still result in the desired effect subsequently to chewing of the chewing gum, which to a certain degree will result in a mixing of at least some of the available enzyme concentration of the coat with the substrate, i.e. the at least one polymer of the chewing gum. In this context, a chewing gum coat or e.g. a center filling or a part of a center filling is regarded as a part of the chewing gum, although most applications refer to a chewing gum and the coating as two separate parts of a tablet.

In an embodiment of the invention, said chewing gum ingredients comprise sweeteners and flavors.

In an embodiment of the invention, said chewing gum ingredients comprise softeners and further additives.

In an embodiment of the invention, said at least one polymer constitutes a chewing gum base.

In an embodiment of the invention, said at least one polymer comprises at least one copolymer.

In an embodiment of the invention, said at least one copolymer is polymerized of at least two different monomers, each comprising 1-99%.

Copolymerization provides a polymer having a relatively low crystallinity, whereby amorphous regions provide an improved degradability.

In an embodiment of the invention, said at least one polymer comprises at least one biodegradable polymer.

In an embodiment of the invention said chewing gum comprises at least one biodegradable polymer and at least one type of enzyme.

According to the invention, a chewing gum comprising biodegradable polymer and enzymes exhibits an improved degradability.

Application of at least one polymer generally regarded as biodegradable may increase the effect of incorporated enzymes in the sense that biodegradable polymers may have a high degree of susceptibility to enzymatic influence.

Some useful biodegradable polymers may be copolymerized from different monomers, which copolymerization may facilitate amorphous regions and consequently the biodegradable polymers may be even more susceptible to enzymatic attack.

In an embodiment of the invention, said at least one biodegradable polymer comprises at least one biodegradable elastomer.

In an embodiment of the invention, said at least one biodegradable polymer comprises at least one biodegradable elastomer plasticizer.

In an embodiment of the invention, at least one of said at least one biodegradable polymer comprises at least one polyester polymer obtained by polymerization of at least one cyclic ester.

Preferably, such a polymerization is a ring opening polymerization of cyclic esters, which provides an aliphatic polyester polymer, which is more susceptible to enzymatic degradation than aromatic polyesters. By polymerization of rings such as lactide, the ultimate degradation product is known to be lactic acid, which is not harmful to the environment and in case of a slight degradation in the chewing gum before it is wasted lactic acid may even have a positive effect on the taste in fruit flavored chewing gum.

In an embodiment of the invention, at least one of said at least one biodegradable polymer comprises at least one polyester polymer obtained by polymerization of at least one alcohol or derivative thereof and at least one acid or derivative thereof.

In an embodiment of the invention, at least one of said at least one biodegradable polymer comprises at least one polyester obtained by polymerization of at least one compound selected from the group of cyclic esters, alcohols or derivatives thereof and carboxylic acids or derivatives thereof.

In an embodiment of the invention, said at least one polyester obtained by polymerization of at least one cyclic ester is at least partly derived from α-hydroxy acids such as lactic and glycolic acids.

In an embodiment of the invention said at least one polyester obtained by polymerization of at least one cyclic ester is at least partly derived from α-hydroxy acids and where the obtained polyester comprises at least 20 mole % α-hydroxy acids units, preferably at least 50 mole % α-hydroxy acids units and most preferably at least 80 mole % α-hydroxy acids units.

In an embodiment of the invention, the at least one or more cyclic esters are selected from the groups of glycolides, lactides, lactones, cyclic carbonates or mixtures thereof.

In an embodiment of the invention, said lactone monomers are chosen from the group of ε-caprolactone, δ-valerolactone, γ-butyrolactone, and β-propiolactone. It also includes ε-caprolactones, δ-valerolactones, γ-butyrolactones, or β-propiolactones that have been substituted with one or more alkyl or aryl substituents at any non-carbonyl carbon atoms along the ring, including compounds in which two substituents are contained on the same carbon atom.

In an embodiment of the invention, the carbonate monomer is selected from the group of trimethylene carbonate, 5-alkyl-1,3-dioxan-2-one, 5,5-dialkyl-1,3-dioxan-2-one, or 5-alkyl-5-alkyloxycarbonyl-1,3-dioxan-2-one, ethylene carbonate, 3-ethyl-3-hydroxymethyl, propylene carbonate, trimethylolpropane monocarbonate, 4,6dimethyl-1,3-propylene carbonate, 2,2-dimethyl trimethylene carbonate, and 1,3-dioxepan-2-one and mixtures thereof.

In an embodiment of the invention, cyclic ester polymers and their copolymers resulting from the polymerization of cyclic ester monomers are comprising poly(L-lactide); poly(D-lactide); poly(D, L-lactide); poly(mesolactide); poly(glycolide); poly(trimethylenecarbonate); poly(epsilon-caprolactone); poly(L-lactide-co-D, L-lactide); poly(L-lactide-co-meso-lactide); poly(L-lactide-co-glycolide); poly(L-lactide-co-trimethylenecarbonate); poly(L-lactide-co-epsilon-caprolactone); poly(D, L-lactide-co-meso-lactide); poly(D, L-lactide-co-glycolide); poly(D, L-lactide-co-trimethylenecarbonate); poly(D, L-lactide-co-epsilon-caprolactone); poly(meso-lactide-co-glycolide); poly(meso-lactide-co-trimethylenecarbonate); poly(meso-lactide-co-epsilon-caprolactone); poly(glycolide-cotrimethylenecarbonate); poly(glycolide-co-epsilon-caprolactone).

In an embodiment of the invention, said at least one polymer has a degree of crystallinity in the range of 0 to 95% and more preferably 0 to 70%.

Preferably chewing gum according to the invention comprises polymers having low-crystallinity regions, due to the fact that enzyme catalyzed degradation may occur more readily in polymer regions having low crystallinity than regions having higher crystallinity. In some cases enzymatic degradation may degrade amorphous regions and leave the polymer partly degraded having only crystalline regions left.

In an embodiment of the invention, at least one of said at least one polymer has amorphous regions.

In an embodiment of the invention, said at least one polymer is aliphatic.

In an embodiment of the invention, the molecular weight of said at least one polymer is in the range of 500-500000 g/mol, preferably within the range of 1500-200000 g/mol Mn.

In an embodiment of the invention, at least one of said enzymes catalyzes the degradation of said at least one polymer.

In an embodiment of the invention, said chewing gum after use is partly disintegrated due to the influence of said enzymes.

The chewing gum lump remaining after use may change its structure due to enzymatic influence, and experiments have shown that the chewing gum lump when some conditions are fulfilled releases from surfaces to which the lump is attached. In other words non-tack may be obtained even without any visual disintegration of the lump.

In an embodiment of the invention, at least one of said enzymes influences the polymer substrate with a partial disintegration of the chewing gum as a result.

In an embodiment of the invention, at least one of said enzymes influences the polymer substrate with a partial disintegration and a crumbling structure of the chewing gum as a result.

The chewing gum lump remaining after use, may due to enzymatic catalysis be partly degraded, whereby the remaining parts are crumbles that are easily removed outdoors by environmental factors, like for example weather conditions such as rain and indoors by physical factors such as a brush or a vacuum cleaner.

In an embodiment of the invention, at least one of said enzymes is after use of the chewing gum catalyzing the polymer substrate degradation until said at least one polymer is completely degraded.

When a complete degradation is obtained the polymer residues are basic compounds, which may enter the cycle in nature.

In an embodiment of the invention, at least one of said enzymes is active in atmospheric air and pressure and are accelerating the degradation of said at least one polymer.

The natural outdoor environment is an important factor for the enzymatic degradation to occur. The enzyme activity should have an optimum under atmospheric conditions.

In an embodiment of the invention at least one of said enzymes is contained in the chewing gum, gum base, center filling or coating.

According to the invention, enzymes may be placed in either of the chewing gum parts and still provide a degradation acceleration subsequently to mixing of enzymes and polymer substrate during chewing.

In an embodiment of the invention, at least one of said enzymes is accelerating the degradation of said polyester obtained by ring opening polymerization of at least one cyclic ester.

In an embodiment of the invention, at least one of said enzymes is accelerating the degradation of said polyester obtained by polymerization of at least one alcohol or derivative thereof and at least one acid or derivative thereof.

Studies have shown that polyesters belonging to these two polyester groups were especially susceptible to the catalytic influence of enzymes on their degradation. Therefore, application of these polymers in enzyme-containing chewing gum may provide for a particularly degradable chewing gum.

In an embodiment of the invention, said chewing gum comprises at least one polyester obtained by ring opening polymerization of at least one cyclic ester and at least one polyester obtained by polymerization of at least one alcohol or derivative thereof and at least one acid or derivative thereof.

In an embodiment of the invention the chewing gum has water content of less than 10 wt %, preferably less than 5 wt %, more preferably less than 1 wt % and most preferably less than 0.1 wt %.

As long as the chewing gum has not been used it is important to keep the water content low to prevent the chewing gum from degrading e.g. a hydrolytically degradation catalyzed by hydrolase enzymes.

In an embodiment of the invention, the chewing gum is capable of absorbing water in an amount of at least 0.1 wt %, preferably at least 5 wt %, more preferably at least 10 wt %, even more preferably at least 20 wt % and most preferably at least 40 wt %.

When water is absorbed into the chewing gum the conditions for hydrolytic degradation to take place are improved. The water absorption is an important parameter to control the degradability of biodegradable chewing gum. This is especially important, when the applied enzymes are hydrolases.

In an embodiment of the invention, the chewing gum comprises filler in an amount of 0 to 80 wt %.

The filler content may provide the chewing gum with higher water uptake capability and thus more favorable conditions for enzymatically accelerated degradation as for example hydrolysis and oxidation.

In an embodiment of the invention, the concentration of said enzymes is in the range of 0.0001 wt % to 50 wt % of the chewing gum.

A high enzyme concentration results in more degradation with respect to rate and completeness. Moreover, high concentration will more likely result in increased concentration of enzymes in the chewed chewing gum. However, if the enzyme concentration is too high the enzymatic degradation may be hindered.

In an embodiment of the invention, the concentration of said enzymes is in the range of 0.001 wt % to 10 wt % of the chewing gum.

In an embodiment of the invention, the concentration of said enzymes is in the range of 0.01 wt % to 5 wt % of the chewing gum.

In an embodiment of the invention, the amount of said enzymes is in the range of 0.0001 to 80 wt % related to the amount of gum base in the chewing gum.

In an embodiment of the invention, the amount of said enzymes is in the range of 0.001 to 40 wt % related to the amount of gum base in the chewing gum.

In an embodiment of the invention, the amount of said enzymes is in the range of 0.1 to 20 wt % related to the amount of gum base in the chewing gum.

In an embodiment of the invention, at least one of said enzymes is selected from the group consisting of oxidoreductases, transferases, hydrolases, lyases, isomerases and ligases.

In an embodiment of the invention, at least one of said enzymes is an oxidoreductase.

In an embodiment of the invention, at least one of said enzymes is a hydrolase.

In an embodiment of the invention, at least one of said enzymes is a lyase.

In an embodiment of the invention, at least one of said hydrolase enzymes is acting on ester bonds.

In an embodiment of the invention, at least one of said hydrolase enzymes is a glycosylase.

In an embodiment of the invention, at least one of said hydrolase enzymes is acting on ether bonds.

In an embodiment of the invention, at least one of said hydrolase enzymes is acting on carbon-nitrogen bonds.

In an embodiment of the invention, at least one of said hydrolase enzymes is acting on peptide bonds.

In an embodiment of the invention, at least one of said hydrolase enzymes is acting on acid anhydrides.

In an embodiment of the invention, at least one of said hydrolase enzymes is acting on carbon-carbon bonds.

In an embodiment of the invention, at least one of said hydrolase enzymes is acting on halide bonds, phosphorus-nitrogen bonds, sulfur-nitrogen bonds, carbon-phosphorus bonds, sulfur-sulfur bonds or carbon-sulfur bonds.

In an embodiment of the invention, at least one of said enzymes is selected from the group of lipases, esterases, depolymerases, peptidases and proteases.

Due to the polymeric nature of the substrate according to the invention, such enzymes as different depolymerases are suitable for its degradation owing to their capability to catalyze degradation of different polymer types. Also lipases may be used for polymer degradation, since they are able to cleave bonds found in oil and solid phases. As regards some preferred polymers containing ester bonds the most convenient enzymes may generally fall into the group of esterases. Likewise peptidases and proteases have been found to cleave various polymeric substrates.

In an embodiment of the invention, at least one of said enzymes is an endo-enzyme.

In an embodiment of the invention, at least one of said enzymes is an exo-enzyme.

In an embodiment of the invention, at least one of said enzymes has a molecular weight of 2 to 1000 kDa, preferably 10 to 500 kDa.

In an embodiment of the invention, at least two of said enzymes are combined. In the present context a combination of at least two enzymes means that these enzymes are added in the same chewing gum. By addition of at least two different types of enzymes, for example two different hydrolases or e.g. a hydrolase and an oxidoreductase in the same chewing gum the enzymatic influence on degradation may be significantly improved.

In an embodiment of the invention, at least one of said enzymes requires a co-factor to carry out its catalyzing function.

In an embodiment of the invention, at least one of said enzymes is incorporated in the chewing gum.

In an embodiment of the invention, at least one of said enzymes is incorporated in the gum base

In an embodiment of the invention, at least one of said enzymes is incorporated in the coating.

In nature by environmental factors the degradation progresses mainly at the surface of e.g. polymers, but by incorporation of enzymes in chewing gum the degradation proceeds from the inside also, whereby disintegration of the gum may begin at an earlier stage during the degradation.

In an embodiment of the invention at least one of said enzymes has optimum activity in the pH range from 1.0 to 11.0, preferably 4.0 to 8.0 and most preferably 4.0 to 6.0.

In an embodiment of the invention, at least one of said enzymes has optimum activity at temperatures in the range of −10 to 60° C., preferably 0 to 50° C., more preferably 5 to 40° C. and most preferably 10 to 35° C.

In an embodiment of the invention, at least one of said enzymes has optimum activity in a relative humidity in the range of 10 to 100% RH, preferably 30 to 100% RH.

Preferably the enzymatic influence of said enzymes on chewing gum polymer degradation is considerable under the chemical and physical conditions typically found in natural environment, where the chewing gum may be deposited.

In an embodiment of the invention, said chewing gum is prepared by a one-step process.

In an embodiment of the invention, said chewing gum is prepared by a two-step process.

In an embodiment of the invention, said chewing gum is prepared by a continuous mixing process.

In an embodiment of the invention, said chewing gum is compressed and prepared by use of compression techniques.

Moreover, the invention relates to use of at least one enzyme for degradation of biodegradable chewing gum.

In an embodiment of the invention, at least one enzyme comprises hydrolases.

Moreover, the invention relates to at least one biodegradable polymer being at least partly degraded by means of at least one enzyme.

In an embodiment of the invention, said enzyme is mixed together with said at least one biodegradable polymer by chewing.

### FIGURES

The invention will be described with reference to the following figures, which illustrate the formation of degradation products as measured by head space GC/MS:

FIG. 1 Illustrates the formation of compound a and b in chewing gum containing glucose oxidase.

FIG. 2 Illustrates the formation of compound a and b in chewing gum containing neutrase.

FIG. 3 Illustrates the formation of compound a and b in chewing gum containing bromelain.

FIG. 4 Illustrates the formation of compound a and b in chewing gum containing trypsin.

### DETAILED DESCRIPTION

The present invention relates to chewing gum comprising biodegradable polymers, chewing gum ingredients and enzymes. By these means a chewing gum may be provided, wherein the polymers constitute substrates for the enzymes and consequently are at least partly degraded.

According to the invention, a method is obtained through which biodegradable polymers in chewing gum may be degraded by means of enzymes, which may result in increased polymer degradation with respect to rate and extent of degradation as compared to non-enzymatic degradation.

It is realized that use of enzymes for the purpose of chewing gum polymer degradation may advantageously facilitate the possibility to include polymers that under normal circumstances are regarded as having a limited biodegradability and therefore to some extent are avoided in biodegradable chewing gum compositions. The favorable influence on the desired texture that these polymers may have may due to the use of enzymes be obtained without compromising the chewing gum degradability.

In an embodiment of the invention, degradation of a biodegradable polymer is improved and/or accelerated when applied under environmental conditions under which biodegradation would not occur untriggered.

If chewing gum is disposed in earth in outdoor environments, there are a lot of chemical, physical and biological factors, whereby degradation of biodegradable polymers is facilitated. But falling on for example pavements or indoors the chewing gum may not meet the required circumstances for degradation. In that case even biodegradable chewing gum may be of inconvenience. A solution according to the present invention facilitates acceleration of the degradation in environments, where the conditions are only slightly degrading. The presence of enzymes makes the degradation process progress faster than if the only influences are physical- and/or chemical factors in the surroundings.

According to a preferred definition of biodegradability according to the invention, biodegradability is a property of certain organic molecules whereby, when exposed to the natural environment or placed within a living organism, they react through an enzymatic or microbial process, often in combination with a chemical process such as hydrolysis, to form simpler compounds, and ultimately carbon dioxide, nitrogen oxides, methane, water and the like.

In the present context the term ‘biodegradable polymers’ means environmentally or biologically degradable polymer compounds and refers to chewing gum base components which, after dumping the chewing gum, are capable of undergoing a physical, chemical and/or biological degradation whereby the dumped chewing gum waste becomes more readily removable from the site of dumping or is eventually disintegrated to lumps or particles, which are no longer recognizable as being chewing gum remnants. The degradation or disintegration of such degradable polymers may be effected or induced by physical factors such as temperature, light, moisture, etc., by chemical factors such as oxidative conditions, pH, hydrolysis, etc. or by biological factors such as microorganisms and/or enzymes. The degradation products may be larger oligomers, trimers, dimers and monomers.

Preferably, the ultimate degradation products are small inorganic compounds such as carbon dioxide, nitrogen oxides, methane, ammonia, water, etc.

In some useful embodiments all of the polymer components of the gum base are environmentally or biologically degradable polymers.

In the present context the term ‘enzyme’ is used in the same sense as it is used within the arts of biochemistry and molecular biology. Enzymes are biological catalysts, typically proteins, but non-proteins with enzymatic properties have been discovered. Enzymes originate from living organisms where they act as catalysts and thereby regulate the rate at which chemical reactions proceed without themselves being altered in the process. The biological processes that occur within all living organisms are chemical processes, and enzymes regulate most of them. Without enzymes, many of these reactions would not take place at a perceptible rate. Enzymes catalyze all aspects of cell metabolism. This includes the conservation and transformation of chemical energy, the construction of cellular macromolecules from smaller precursors and the digestion of food, in which large nutrient molecules such as proteins, carbohydrates, and fats are broken down into smaller molecules.

Generally enzymes have valuable industrial and medical applications. The fermenting of wine, leavening of bread, curdling of cheese, and brewing of beer have been practiced from earliest times, but not until the 19th century were these reactions understood to be the result of the catalytic activity of enzymes. Since then, enzymes have assumed an increasing importance in industrial processes that involve organic chemical reactions. The investigations and developing of enzymes are still on going and new applications of enzymes are discovered. Synthetic polymers are often regarded as hardly degradable by enzymes and theories explaining this phenomenon have been proposed suggesting that enzymes tend to attack chain ends and that chain ends of man-made polymers tend to be deep in the polymer matrix. However, experiments according to the present invention surprisingly showed that the effect of adding enzymes in chewing gum apparently was that the polymers of the chewing gum experienced more degradation.

As catalysts enzymes generally may increase the rate of attainment of an equilibrium between reactants and products of chemical reactions. According to the present invention these reactants comprise polymers and different degrading molecules such as water, oxygen or other reactive substances, which may come into the vicinity of the polymers, whereas the products comprise oligomers, trimers, dimers, monomers and smaller degradation products. When reactions are enzyme catalyzed, at least one of the reactants forms a substrate for at least one enzyme, which means that a temporary binding emerges between reactants i.e. enzyme substrates and enzymes. In different ways this binding makes the reaction proceed faster, for instance by bringing the reactants into conformations or positions that favor reaction. An increase in reaction rate due to enzymatic influence i.e. catalysis generally occurs because of a lowering of an activation energy barrier for the reaction to take place. However, enzymes do not change the difference in free energy level between initial and final states of the reactants and products, as the presence of a catalyst has no effect on the position of equilibrium. When a catalytic process has been completed, the at least one enzyme releases the product or products and returns to its original state, ready for another substrate.

The temporary binding of one or more molecules of substrate happens in regions of the enzymes called the active sites and may for example comprise hydrogen bonds, ionic interactions, hydrophobic interactions or weak covalent bonds. In the complex tertiary structure of enzymes, an active site may assume the shape of a pocket or cleft, which fit particular substrates or parts of substrates. Some enzymes have a very specific mode of action, whereas others have a wide specificity and may catalyze a series of different substrates. Basically molecular conformation is important to the specificity of enzymes, and they may be rendered active or inactive by varying pH, temperature, solvent, etc. Yet some enzymes require co-enzymes or other co-factors to be present in order to be effective, in some cases forming association complexes in which a co-enzyme acts as a donor or acceptor for a specific group. Some times enzymes may be specified as endo-enzymes or exo-enzymes, thereby referring to their mode of action. According to this terminology exo-enzymes may successively attack chain ends of polymer molecules and thereby for instance liberate terminal residues or single units, whereas endo-enzymes may attack mid-chain and act on interior bonds within the polymer molecules, thereby cleaving larger molecules to smaller molecules. Generally enzymes may be attainable as liquids or powders and eventually be encapsulated in various materials.

Today, several thousand different enzymes have been discovered and more are continuously being discovered, thus the number of known enzymes is still increasing. For this reason the Nomenclature Committee of the International Union of Biochemistry and Molecular Biology (NC-IUBMB) has established a rational naming and numbering system. In the present context enzyme names are used in accordance with the recommendations devised by NC-IUBMB.

The general principles in manufacturing an embodiment according to the invention will now be described together with a general description of the obtained product.

Two quite different aspects of the invention will now shortly be summarized. A first aspect according to an embodiment of the invention is to address the possibility of increasing the degradability of a biodegradable chewing gum applied in a chewing gum having a polymer matrix solely or partly comprising biodegradable polymers. A second quite different aspect is rather to facilitate use of conventional polymers or biodegradable polymers, which without any catalyzing enzyme is less suitable for the application with respect to, for example, degradation rate.

In short, those and further aspects are obtained by applying enzymes in chewing gum as degradation triggers and catalysts. In others words, according to the invention, at least one biodegradable polymer of a chewing gum forms a substrate paired with a suitable enzyme. Several different criteria must be considered when determining which enzymes should be paired with which polymers, by which processes, etc.

According to four preferred embodiments of the invention, an enzyme containing biodegradable chewing gum may be prepared by either a conventional two-step batch process, a less used but quite promising one-step process or e.g. a continuous mixing performed e.g. by means of an extruder and the fourth preferred embodiment is to prepare the chewing gum by use of compression techniques.

The two-step process comprises separate manufacturing of gum base and subsequently mixing of gum base with further chewing gum ingredients. Several other methods may be applied as well. Examples of two-step processes are well described in the prior art. An example of a one-step process is disclosed in WO 02/076229 A1, hereby included by reference. Examples of continuous mixing methods are disclosed in U.S. Pat. No. 6,017,565 A, U.S. Pat. No. 5,976,581 A and U.S. Pat. No. 4,968,511 A, hereby included by reference. Examples of processes to produce compressed chewing gum are disclosed in U.S. Pat. No. 4,405,647, U.S. Pat. No. 4,753,805, WO 8603967, EP 513978, U.S. Pat. No. 5,866,179, WO/197/21424, EP 0 890 358, DE 19751330, U.S. Pat. No. 6,322,828, PCT/DK03/00070, PCT/DK03/00465, hereby included by reference.

If a two-step process is applied, care should be taken, e.g. in avoiding too much heating of the applied enzymes. This may e.g. be done by mixing the applied enzyme(s) into the chewing gum in the second step, i.e. in the step where the gum base is mixed with the chewing gum ingredients.

If a one-step process is applied, the same problem should be observed, although the one-step process in some ways appears to be quite suitable for the purpose and in some processes temperature control or cooling may in fact be avoided.

If a continuous mixing method is applied, again, the active cooling and heating should be carefully controlled to avoid the above-described destruction or damaging of the applied enzyme(s).

Turning now to one of several principal embodiments of the invention, a chewing gum will be described in more general terms.

First of all, the chewing gum comprises a polymer composition, which is partly or solely based on biodegradable polymers. These polymers are, as it is the case with conventional non-degradable chewing gum, the components of the chewing gum providing the texture and “masticatory” properties of a chewing gum. Lists of suitable and preferred polymers according to the invention are described below (at the end of the description).

Moreover, the chewing gum comprises further additives applied for obtaining the desired fine-tuning of the above-mentioned chewing gum. Such additives may e.g. comprise softeners, emulsifiers, etc. Lists of such suitable and preferred additives are described below (at the end of the description).

Moreover, the chewing gum comprises further ingredients applied for obtaining the desired taste and properties of the above-mentioned chewing gum. Such ingredients may e.g. comprise sweeteners, flavors, acids, etc. Lists of such suitable and preferred ingredients are described below (at the end of the description).

It should be stressed that the above-mentioned additives and ingredients may interact in function. As an example, flavors may e.g. be applied as or act as softeners in the complete system. A strict distinction between additives and ingredients may typically not be established.

Furthermore, a coating may be applied for complete or partial encapsulation of the obtained chewing gum center. In the present context coating and center filling are regarded as a whole, thus using the term “chewing gum” includes both the chewing gum body and an optional coating. Examples of different coatings are described below (at the end of the description).

Advantages according to the invention are that a partial disintegration or non-tack improvement of the chewing gum lump may be obtained. A further explanation of the advantages is given in two separate examples. One example is when enzymatic influences result in a partial disintegration and a crumbly structure of the lump thereby releasing the lump forming ingredients from the surface. Another example deals with a situation in which the chewing gum lump changes its structure due to enzymatic influence and where experiments have shown that the chewing gum lump when some conditions are fulfilled releases from surfaces to which the lump is attached. In other words, this non-tack property may be obtained even without any visual disintegration of the lump.

It is a further advantage according to the invention that completely dissolving may be obtained, which means that the polymer residues may enter the cycle in nature. Incorporation of enzymatic influences results in completely biodegradable chewing gum polymers.

In accordance with the general principles in manufacturing an embodiment according to the invention, suitable examples of polymers, enzymes and chewing gum ingredients will be outlined in the following.

Suitable examples of environmentally or biologically degradable chewing gum base polymers, which may be applied in accordance with the gum base of the present invention, include degradable polyesters, poly(ester-carbonates), polycarbonates, polyester amides, polypeptides, homopolymers of amino acids such as polylysine, and proteins including derivatives thereof such as e.g. protein hydrolysates including a zein hydrolysate. Particularly useful compounds of this type include polyester polymers obtained by the polymerization of one or more cyclic esters such as lactide, glycolide, trimethylene carbonate, δ-valerolactone, β-propiolactone and ε-caprolactone, and polyesters obtained by polycondensation of a mixture of open-chain polyacids and polyols, for example, adipic acid and di(ethylene glycol). Hydroxy carboxylic acids such as 6-hydroxycaproic acid may also be used to form polyesters or they may be used in conjunction with mixtures of polyacids and polyols. Such degradable polymers may be homopolymers, copolymers or terpolymers, including graft- and block-polymers.

The particularly useful biodegradable polyester compounds produced from cyclic esters may be obtained by ring-opening polymerization of one or more cyclic esters, which includes glycolides, lactides, lactones and carbonates. The polymerization process may take place in the presence of at least one appropriate catalyst such as metal catalysts, of which stannous octoate is a non-limiting example and the polymerization process may be initiated by initiators such as polyols, polyamines or other molecules with multiple hydroxyl or other reactive groups and mixtures thereof.

Accordingly, the particularly useful biodegradable polyesters produced through reaction of at least one alcohol or derivative thereof and at least one acid or derivative thereof may generally be prepared by step-growth polymerization of di-, tri- or higher-functional alcohols or esters thereof with di-, tri- or higher-functional aliphatic or aromatic carboxylic acids or esters thereof. Likewise, also hydroxy acids or anhydrides and halides of polyfunctional carboxylic acids may be used as monomers. The polymerization may involve direct polyesterification or transesterification and may be catalyzed. Use of branched monomers suppresses the crystallinity of the polyester polymers. Mixing of dissimilar monomer units along the chain also suppresses crystallinity. To control the reaction and the molecular weight of the resulting polymer the polymer chains may be ended by addition of monofunctional alcohols or acids and/or to utilize a stoichiometric imbalance between acid groups and alcohol groups or derivatives of either. Also the adding of long chain aliphatic carboxylic acids or aromatic monocarboxylic acids may be used to control the degree of branching in the polymer and conversely multifunctional monomers are sometimes used to create branching. Moreover, following the polymerization monofunctional compounds may be used to endcap the free hydroxyl and carboxyl groups.

Furthermore, polyfunctional carboxylic acids are in general high-melting solids that have very limited solubility in the polycondensation reaction medium. Often esters or anhydrides of the polyfunctional carboxylic acids are used to overcome this limitation. Polycondensations involving carboxylic acids or anhydrides produce water as the condensate, which requires high temperatures to be driven off. Thus, polycondensations involving transesterification of the ester of a polyfunctional acid are often the preferred process. For example, the dimethyl ester of terephthalic acid may be used instead of terephthalic acid itself. In this case, methanol rather than water is condensed, and the former can be driven off more easily than water. Usually, the reaction is carried out in the bulk (no solvent) and high temperatures and vacuum are used to remove the by-product and drive the reaction to completion. In addition to an ester or anhydride, a halide of the carboxylic acid may also be used under certain circumstances.

Additionally for preparation of polyesters of this type the preferred polyfunctional carboxylic acids or derivatives thereof are usually either saturated or unsaturated aliphatic or aromatic and contain 2 to 100 carbon atoms and more preferably 4 to 18 carbon atoms. In the polymerization of this type of polyester some applicable examples of carboxylic acids, which may be employed as such or as derivatives thereof, includes aliphatic polyfunctional carboxylic acids such as oxalic, malonic, citric, succinic, malic, tartaric, fumaric, maleic, glutaric, glutamic, adipic, glucaric, pimelic, suberic, azelaic, sebacic, dodecanedioic acid, etc. and cyclic aliphatic polyfunctional carboxylic acids such as cyclopropane dicarboxylic acid, cyclobutane dicarboxylic acid, cyclohexane dicarboxylic acid, etc. and aromatic polyfunctional carboxylic acids such as terephthalic, isophthalic, phthalic, trimellitic, pyromellitic and naphthalene 1,4-, 2,3-, 2,6-dicarboxylic acids and the like. For the purpose of illustration and not limitation, some examples of carboxylic acid derivatives include hydroxy acids such as 3-hydroxy propionic acid and 6-hydroxycaproic acid and anhydrides, halides or esters of acids, for example dimethyl or diethyl esters, corresponding to the already mentioned acids, which means esters such as dimethyl or diethyl oxalate, malonate, succinate, fumarate, maleate, glutarate, adipate, pimelate, suberate, azelate, sebacate, dodecanedioate, terephthalate, isophthalate, phthalate, etc. Generally speaking, methyl esters are sometimes more preferred than ethyl esters due to the fact that higher boiling alcohols are more difficult to remove than lower boiling alcohols.

Furthermore, the usually preferred polyfunctional alcohols contain 2 to 100 carbon atoms as for instance polyglycols and polyglycerols. In the polymerization process of this type of polyester some applicable examples of alcohols, which may be employed as such or as derivatives thereof, includes polyols such as ethylene glycol, 1,2-propanediol, 1,3-propanediol, 1,3-butanediol, 1,4-butanediol, 1,6-hexanediol, diethylene glycol, 1,4-cyclohexanediol, 1,4-cyclohexanedimethanol, neopentyl glycol, glycerol, trimethylolpropane, pentaerythritol, sorbitol, mannitol, etc. For the purpose of illustration and not limitation, some examples of alcohol derivatives include triacetin, glycerol palmitate, glycerol sebacate, glycerol adipate, tripropionin, etc.

Additionally, with regard to polymerization of polyesters of this type the chain-stoppers sometimes used are monofunctional compounds. They are preferably either monohydroxy alcohols containing 1-20 carbon atoms or monocarboxylic acids containing 2-26 carbon atoms. General examples are medium or long-chain fatty alcohols or acids, and specific examples include monohydroxy alcohols such as methanol, ethanol, butanol, hexanol, octanol, etc. and lauryl alcohol, myristyl alcohol, cetyl alcohol, stearyl alcohol, stearic alcohol, etc. and monocarboxylic acids such as acetic, lauric, myristic, palmitic, stearic, arachidic, cerotic, dodecylenic, palmitoleic, oleic, linoleic, linolenic, erucic, benzoic, naphthoic acids and substituted napthoic acids, 1-methyl-2 naphthoic acid and 2-isopropyl-1-naphthoic acid, etc.

Moreover an acid catalyst or a transesterification catalyst is typically used in the polymerization of polyesters of this type and non-limiting examples of those are the metal catalysts such as acetates of manganese, zinc, calcium, cobalt or magnesium, and antimony(III)oxide, germanium oxide or halide and tetraalkoxygermanium, titanium alkoxide, zinc or aluminum salts.

Suitable enzymes in accordance with the general principles in manufacturing an embodiment within the scope of the present invention may be identified as belonging to six classes according to their function: Oxidoreductases, transferases, hydrolases, lyases, isomerases and ligases. Oxidoreductases catalyze oxidation-reduction reactions, and the substrate oxidized is regarded as hydrogen or electron donor. Transferases catalyze transfer of functional groups from one molecule to another. Hydrolases catalyze hydrolytic cleavage of various bonds. Lyases catalyze cleavage of various bonds by other means than by hydrolysis or oxidation, meaning for example that they catalyze removal of a group from or addition of a group to a double bond, or other cleavages involving electron rearrangement. Isomerases catalyze intramolecular rearrangement, meaning changes within one molecule. Ligases catalyze reactions in which two molecules are joined.

Some preferred enzymes according to the invention are oxidoreductases, which may act on different groups of donors, such as the CH—OH group, the aldehyde or oxo group, the CH—CH group, the CH—NH₂ group, the CH—NH group, NADH or NADPH, nitrogenous compounds, a sulfur group, a heme group, diphenols and related substances, hydrogen, single donors with incorporation of molecular oxygen, paired donors with incorporation or reduction of molecular oxygen or others. Oxidoreductases may also be acting on CH₂ groups or X—H and Y—H to form an X-Y bond. Typically enzymes belonging to the group of oxidoreductases may be referred to as oxidases, oxygenases, hydrogenases, dehydrogenases, reductases or the like.

Specific examples of oxidoreductases comprise oxidases such as malate oxidase, glucose oxidase, hexose oxidase, aryl-alcohol oxidase, alcohol oxidase, long-chain-alcohol oxidase, glycerol-3-phosphate oxidase, polyvinyl-alcohol oxidase, D-arabinono-1,4-lactone oxidase, D-mannitol oxidase, xylitol oxidase, oxalate oxidase, carbon-monoxide oxidase, 4-hydroxyphenylpyruvate oxidase, dihydrouracil oxidase, ethanolamine oxidase, L-aspartate oxidase, sarcosine oxidase, urate oxidase, methanethiol oxidase, 3-hydroxyanthranilate oxidase, laccase, catalase, fatty-acid peroxidase, peroxidase, diarylpropane peroxidase, ferroxidase, pteridine oxidase, columbamine oxidase and the like.

Further specific examples of oxidoreductases comprise oxygenases such as catechol 1,2-dioxygenase, gentisate 1,2-dioxygenase, homogentisate 1,2-dioxygenase, lipoxygenase, ascorbate 2,3-dioxygenase, 3-carboxyethylcatechol 2,3-dioxygenase, indole 2,3-dioxygenase, caffeate 3,4-dioxygenase, arachidonate 5-lipoxygenase, biphenyl-2,3-diol 1,2-dioxygenase, linoleate 11-lipoxygenase, acetylacetone-cleaving enzyme, lactate 2-monooxygenase, phenylalanine 2-monooxygenase, inositol oxygenase and the like.

Further specific examples of oxidoreductases comprise dehydrogenases such as alcohol dehydrogenase, glycerol dehydrogenase, propanediol-phosphate dehydrogenase, L-lactate dehydrogenase, D-lactate dehydrogenase, glycerate dehydrogenase, glucose 1-dehydrogenase, galactose 1-dehydrogenase, allyl-alcohol dehydrogenase, 4-hydroxybutyrate dehydrogenase, octanol dehydrogenase, aryl-alcohol dehydrogenase, cyclopentanol dehydrogenase, long-chain-3-hydroxyacyl-CoA dehydrogenase, L-lactate dehydrogenase, D-lactate dehydrogenase, butanal dehydrogenase, terephthalate 1,2-cis-dihydrodiol dehydrogenase, succinate dehydrogenase, glutamate dehydrogenase, glycine dehydrogenase, hydrogen dehydrogenase, 4-cresol dehydrogenase, phosphonate dehydrogenase and the like.

Specific examples of reductases belonging to the group of oxidoreductases comprise enzymes such as diethyl 2-methyl-3-oxosuccinate reductase, tropinone reductase, long-chain-fatty-acyl-CoA reductase, carboxylate reductase, D-proline reductase, glycine reductase and the like.

Other preferred enzymes according to the invention are lyases, which may belong to either of the following groups: carbon-carbon lyases, carbon-oxygen lyases, carbon-nitrogen lyases, carbon-sulfur lyases, carbon-halide lyases, phosphorus-oxygen lyases and other lyases.

Among carbon-carbon lyases are carboxy-lyases, aldehyde-lyases, oxo-acid-lyases and others. Some specific examples belonging to those groups are oxalate decarboxylase, acetolactate decarboxylase, aspartate 4-decarboxylase, lysine decarboxylase, aromatic-L-amino-acid decarboxylase, methylmalonyl-CoA decarboxylase, carnitine decarboxylase, indole-3-glycerol-phosphate synthase, gallate decarboxylase, branched-chain-2-oxoacid, decarboxylase, tartrate decarboxylase, arylmalonate decarboxylase, fructose-bisphosphate aldolase, 2-dehydro-3-deoxy-phosphogluconate aldolase, trimethylamine-oxide aldolase, propioin synthase, lactate aldolase, vanillin synthase, isocitrate lyase, hydroxymethylglutaryl-CoA lyase, 3-hydroxyaspartate aldolase, tryptophanase, deoxyribodipyrimidine photo-lyase, octadecanal decarbonylase and the like.

Among carbon-oxygen lyases are hydro-lyases, lyases acting on polysaccharides, phosphates and others. Some specific examples are carbonate dehydratase, fumarate hydratase, aconitate hydratase, citrate dehydratase, arabinonate dehydratase, galactonate dehydratase, altronate dehydratase, mannonate dehydratase, dihydroxy-acid dehydratase, 3-dehydroquinate dehydratase, propanediol dehydratase, glycerol dehydratase, maleate hydratase, oleate hydratase, pectate lyase, poly(β-D-mannuronate) lyase, oligogalacturonide lyase, poly(α-L-guluronate)lyase, xanthan lyase, ethanolamine-phosphate phospho-lyase, carboxymethyloxysuccinate lyase and others.

Among carbon-nitrogen lyases are ammonia-lyases, lyases acting on amides, amidines, etc., amine-lyases and others. Specific examples of those groups of lyases are aspartate ammonia-lyase, phenylalanine ammonia-lyase, ethanolamine ammonia-lyase, glucosaminate ammonia-lyase, argininosuccinate lyase, adenylosuccinate lyase, ureidoglycolate lyase, 3-ketovalidoxylamine C—N-lyase

Among carbon-sulfur lyases are some specific examples such as dimethylpropiothetin dethiomethylase, alliin lyase, lactoylglutathione lyase and cysteine lyase.

Among carbon-halide lyases are some specific examples such as 3-chloro-D-alanine dehydrochlorinase or dichloromethane dehalogenase.

Among phosphorus-oxygen lyases are some specific examples such as adenylate cyclase, cytidylate cyclase, glycosylphosphatidylinositol diacylglycerol-lyase.

In the most preferred embodiments of the invention, the applied enzymes are hydrolases comprising glycosylases, enzymes acting on acid anhydrides and enzymes acting on specific bonds such as ester bonds, ether bonds, carbon-nitrogen bonds, peptide bonds, carbon-carbon bonds, halide bonds, phosphorus-nitrogen bonds, sulfur-nitrogen bonds, carbon-phosphorus bonds, sulfur-sulfur bonds or carbon-sulfur bonds.

Among the glycosylases the preferred enzymes are glycosidases, which are capable of hydrolysing O— and S-glycosyl compounds or N-glycosyl compounds. Some examples of glycosylases are α-amylase, β-amylase, glucan 1,4-α-glucosidase, cellulase, endo-1,3(4)-β-glucanase, inulinase, endo-1,4-α-xylanase, oligo-1,6-glucosidase, dextranase, chitinase, polygalacturonase, lysozyme, levanase, quercitrinase, galacturan 1,4-α-galacturonidase, isoamylase, glucan 1,6-α-glucosidase, glucan endo-1,2-β-glucosidase, licheninase, agarase, exo-poly-α-galacturonosidase, κ-carrageenase, steryl-β-glucosidase, strictosidine β-glucosidase, mannosyl-oligosaccharide glucosidase, lactase, oligoxyloglucan β-glycosidase, polymannuronate hydrolase, chitosanase, poly(ADP-ribose) glycohydrolase, purine nucleosidase, inosine nucleosidase, uridine nucleosidase, adenosine nucleosidase and others.

Among enzymes acting on acid anhydrides are for instance those acting on phosphorus- or sulfonyl-containing anhydrides. Some examples of enzymes acting on acid anhydrides are inorganic diphosphatase, trimetaphosphatase, adenosine-triphosphatase, apyrase, nucleoside-diphosphatase, acylphosphatase, nucleotide diphosphatase, endopolyphosphatase, exopolyphosphatase, nucleoside phospho-acylhydrolase, triphosphatase, CDP-diacylglycerol-diphosphatase, undecaprenyl-diphosphatase, dolichyldiphosphatase, oligosaccharide-diphosphodolichol diphosphatase, heterotrimeric G-protein GTPase, small monomeric GTPase, dynamin GTPase, tubulin GTPase, diphosphoinositol-polyphosphate diphosphatase, H⁺-exporting ATPase, monosaccharide-transporting ATPase, maltose-transporting ATPase, glycerol-3-phosphate-transporting ATPase, oligopeptide-transporting ATPase, polyamine-transporting ATPase, peptide-transporting ATPase, fatty-acyl-CoA-transporting ATPase, protein-secreting ATPase and others.

Most preferred enzymes of the present invention are those acting on ester bonds, among which are carboxylic ester hydrolases, thiolester hydrolases, phosphoric ester hydrolases, sulfuric ester hydrolases and ribonucleases. Some examples of enzymes acting on ester bonds are acetyl-CoA hydrolase, palmitoyl-CoA hydrolase, succinyl-CoA hydrolase, 3-hydroxyisobutyryl-CoA hydrolase, hydroxymethylglutaryl-CoA hydrolase, hydroxyacylglutathione hydrolase, glutathione thiolesterase, formyl-CoA hydrolase, acetoacetyl-CoA hydrolase, S-formylglutathione hydrolase, S-succinyl-glutathione hydrolase, oleoyl-[acyl-carrier-protein]hydrolase, ubiquitin thiolesterase, [citrate-(pro-3S)-lyase]thiolesterase, (S)-methylmalonyl-CoA hydrolase, ADP-dependent short-chain-acyl-CoA hydrolase, ADP-dependent medium-chain-acyl-CoA hydrolase, acyl-CoA hydrolase, dodecanoyl-[acyl-carrier protein]hydrolase, palmitoyl-(protein) hydrolase, 4-hydroxybenzoyl-CoA thioesterase, 2-(2-hydroxy-phenyl)benzenesulfinate hydrolase, alkaline phosphatase, acid phosphatase, phospho-serine phosphatase, phosphatidate phosphatase, 5′-nucleotidase, 3′-nucleotidase, 3′(2′),5′-bisphosphate nucleotidase, 3-phytase, glucose-6-phosphatase, glycerol-2-phosphatase, phosphoglycerate phosphatase, glycerol-1-phosphatase, mannitol-1-phosphatase, sugar-phosphatase, sucrose-phosphatase, inositol-1 (or 4)-monophosphatase, 4-phytase, phosphatidylglycerophosphatase, ADPphosphoglycerate phosphatase, N-acylneuraminate-9-phosphatase, nucleotidase, polynucleotide 3′-phosphatase, [glycogen-synthase-D]phosphatase, [pyruvate dehydrogenase (lipoamide)]-phosphatase, [acetyl-CoA carboxylase]-phosphatase, 3-deoxy-manno-octulosonate-8-phosphatase, polynucleotide 5′-phosphatase, sugar-terminal-phosphatase, alkylacetylglycerophosphatase, 2-deoxyglucose-6-phosphatase, glucosylglycerol 3-phosphatase, 5-phytase, phosphodiesterase I, glycerophosphocholine phosphodiesterase, phospholipase C, phospholipase D, phosphoinositide phospholipase C, sphingomyelin phosphodiesterase, glycerophosphocholine cholinephosphodiesterase, alkylglycerophosphoethanolamine phosphodiesterase, glycerophosphoinositol glycerophosphodiesterase, arylsulfatase, steryl-sulfatase, glycosulfatase, choline-sulfatase, cellulose-polysulfatase, monomethyl-sulfatase, D-lactate-2-sulfatase, glucuronate-2-sulfatase, prenyl-diphosphatase, aryldialkylphosphatase, diisopropyl-fluorophosphatase, oligonucleotidase, poly(A)-specific ribonuclease, yeast ribonuclease, deoxyribonuclease (pyrimidine dimer), Physarum polycephalum ribonuclease, ribonculease alpha, Aspergillus nuclease S₁, Serratia marcescens nuclease and more.

The most preferred enzymes acting on ester bonds are carboxylic ester hydrolases such as carboxylesterase, arylesterase, triacylglycerol lipase, phospholipase A₂, lyso-phospholipase, acetylesterase, acetylcholinesterase, cholinesterase, tropinesterase, pectinesterase, sterol esterase, chlorophyllase, L-arabinonolactonase, gluconolactonase, uronolactonase, tannase, retinyl-palmitate esterase, hydroxybutyrate-dimer, hydrolase, acylglycerol lipase, 3-oxoadipate enol-lactonase, 1,4-lactonase, galactolipase, 4-pyridoxolactonase, acylcamitine hydrolase, aminoacyl-tRNA hydrolase, D-arabinonolactonase, 6-phosphogluconolactonase, phospholipase A₁, 6-acetylglucose deacetylase, lipoprotein lipase, dihydrocoumarin hydrolase, limonin-D-ring-lactonase, steroid-lactonase, triacetate-lactonase, actinomycin lactonase, orsellinate-depside, hydrolase, cephalosporin-C deacetylase, chlorogenate hydrolase, α-amino-acid, esterase, 4-methyloxaloacetate esterase, carboxymethylenebutenolidase, deoxylimonate A-ring-lactonase, 1-alkyl-2-acetylglycerophosphocholine esterase, fusarinine-C or-nithinesterase, sinapine esterase, wax-ester hydrolase, phorbol-diester hydrolase, phosphatidylinositol deacylase, sialate O-acetylesterase, acetoxybutynylbithiophene deacetylase, acetylsalicylate deacetylase, methylumbelliferyl-acetate deacetylase, 2-pyrone-4,6-dicarboxylate lactonase, N-acetylgalactosaminoglycan deacetylase, juvenile-hormone esterase, bis(2-ethylhexyl)phthalate esterase, protein-glutamate, methylesterase, 11-cis-retinyl-palmitate hydrolase, all-trans-retinyl-palmitate hydro-lase, L-rhamono-1,4-lactonase, 5-(3,4-diacetoxybut-1-ynyl)-2,2′-bithiophene deacetylase, fatty-acyl-ethyl-ester synthase, xylono-1,4-lactonase, cetraxate benzylesterase, acetylalkylglycerol acetylhydrolase, acetylxylan esterase, feruloyl esterase, cutinase, poly(3-hydroxybutyrate) depolymerase, poly(3-hydroxyoctanoate), depolymerase acyloxyacyl hydrolase, acyloxyacyl hydrolase, polyneuridine-aldehyde esterase and others.

Accordingly, enzymes acting on ether bonds include trialkylsulfonium hydrolases and ether hydrolases. Enzymes acting on ether bonds may act on both thioether bonds and on the oxygen equivalent. Specific enzyme examples belonging to these groups are adenosylhomocysteinase, adenosylmethionine hydrolase, isochorismatase, alkenylglycerophosphocholine hydrolase, epoxide hydrolase, trans-epoxysuccinate hydrolase, alkenylglycerophosphoethanolamine hydrolase, leukotriene-A₄ hydrolase, hepoxilin-epoxide hydrolase and limonene-1,2-epoxide hydrolase.

Among enzymes acting on carbon-nitrogen bonds are linear amides, cyclic amides, linear amidines, cyclic amidines, nitriles and other compounds. Specific examples belonging to these groups are asparaginase, glutaminase, ω-amidase, amidase, urease, β-ureidopropionase, arylformamidase, biotimidase, aryl-acylamidase, amino-acylase, aspartoacylase, acetylornithine deacetylase, acyl-lysine deacylase, succinyl-diaminopimelate desuccinylase, pantothenase, ceramidase, choloylglycine hydrolase, N-acetylglucosamine-6-phosphate deacetylase, N-acetylmuramoyl-L-alanine amidase, 2-(acetamidomethylene)succinate hydrolase, 5-aminopentanamidase, formylmethionine deformylase, hippurate hydrolase, N-acetylglucosamine deacetylase, D-glutaminase, N-methyl-2-oxoglutaramate hydrolase, glutamin-(asparagin-)ase, alkylamidase, acylagmatine amidase, chitin deacetylase, peptidyl-glutaminase, N-carbamoyl-sarcosine amidase, N-(long-chain-acyl)ethanolamine deacylase, mimosinase, acetyl-putrescine deacetylase, 4-acetamidobutyrate deacetylase, theanine hydrolase, 2-(hydroxymethyl)-3-(acetamidomethylene)succinate hydrolase, 4-methyleneglutaminase, N-formylglutamate deformylase, glycosphingolipid deacylase, aculeacin-A deacylase, peptide deformylase, dihydropyrimidinase, dihydroorotase, carboxymethylhydantoinase, creatininase, L-lysine-lactamase, arginase, guanidinoacetase, creatinase, allantoicase, cytosine deaminase, riboflavinase, thiaminase, 1-aminocyclopropane-1-carboxylate deamin and more.

Some preferred enzymes of the present invention belong to the group of enzymes acting on peptide bonds, which group is also referred to as peptidases. Peptidases can be further divided into exopeptidases that act only near a terminus of a polypeptide chain and endopeptidases that act internally in polypeptide chains. Enzymes acting on peptide bonds include enzymes selected from the group of aminopeptidases, dipeptidases, di- or tripeptidyl-peptidases, peptidyl-dipeptidases, serine-type carboxypeptidases, metallocarboxypeptidases, cysteine-type carboxypeptidases, omega peptidases, serine endopeptidases, cysteine endopeptidases, aspartic endopeptidases, metalloendopeptidases and threonine endopeptidases. Some specific examples of enzymes belonging to these groups are cystinyl aminopeptidase, tripeptide aminopeptidase, prolyl aminopeptidase, arginyl aminopeptidase, glutamyl aminopeptidase, cytosol alanyl aminopeptidase, lysyl aminopeptidase, Met-X dipeptidase, non-stereospecific dipeptidase, cytosol nonspecific dipeptidase, membrane di-peptidase, dipeptidase E, dipeptidyl-peptidase I, dipeptidyl-dipeptidase, tripeptidyl-peptidase I, tripeptidyl-peptidase II, X-Pro dipeptidyl-peptidase, peptidyl-dipeptidase A, lysosomal Pro-X carboxypeptidase, carboxypeptidase C, acylaminoacyl-peptidase, peptidyl-glycinamidase, β-aspartyl-peptidase, ubiquitinyl hydrolase 1, chymotrypsin, chymotrypsin C, metridin, trypsin, thrombin, plasmin, enteropeptidase, acrosin, α-Lytic endopeptidase, glutamyl endopeptidase, cathepsin G, cucumisin, prolyl oligopeptidase, brachyurin, plasma kallikrein, tissue kallikrein, pancreatic elastase, leukocyte elastase, chymase, cerevisin, hypodermin C, lysyl endopeptidase, endopeptidase La, γ-renin, venombin AB, leucyl endopeptidase, tryptase, scutelarin, kexin, subtilisin, oryzin, endopeptidase K, thermomycolin, thermitase, endopeptidase So, t-plasminogen activator, protein C (activated), pancreatic endopeptidase E, pancreatic elastase II, IgA-specific serine endopeptidase, u-plasminogen activator, venombin A, furin, myeloblastin, semenogelase, granzyme A, granzyme B, streptogrisin A, streptogrisin B, glutamyl endopeptidase II, oligopeptidase B, omptin, togavirin, flavivirin, endopeptidase Clp, proprotein convertase 1, proprotein convertase 2, lactocepin, assemblin, hepacivirin, spermosin, pseudomonalisin, xanthomonalisin, C-terminal processing peptidase, physarolisin, cathepsin B, papain, ficain, chymopapain, asclepain, clostripain, streptopain, actimidain, cathepsin L, cathepsin H, cathepsin T, glycyl endopeptidase, cancer procoagulant, cathepsin S, picomain 3C, picornain 2A, caricain, ananain, stem bromelain, fruit bromelain, legumain, histolysain, caspase-1, gingipain R, cathepsin K, adenain, bleomycin hydrolase, cathepsin F, cathepsin O, cathepsin V, nuclear-inclusion-a endopeptidase, helper-component proteinase, L-peptidase, gingipain K, staphopain, separase, V-cath endopeptidase, cruzipain, calpain-1, calpain-2, pepsin A, pepsin B, gastricsin, chymosin, cathepsin D, nepenthesin, renin, Pro-opiomelanocortin converting enzyme, aspergillopepsin I, aspergillopepsin II, penicillopepsin, rhizopuspepsin, endothiapepsin, mucorpepsin, candidapepsin, saccharopepsin, rhodotorulapepsin, acrocylindropepsin, polyporopepsin, pycnoporopepsin, scytalidopepsin A, scytalidopepsin B, cathepsin E, barrierpepsin, signal peptidase II, plasmepsin I, plasmepsin II, phytepsin, yapsin 1, thermopsin, prepilin peptidase, nodavirus endopeptidase, memapsin 1, memapsin 2, atrolysin A, microbial collagenase, leucolysin, stromelysin 1, meprin A, procollagen C-endopeptidase, astacin, pseudolysin, thermolysin, bacillolysin, aureolysin, coccolysin, mycolysin, gelatinase B, leishmanolysin, saccharolysin, gametolysin, serralysin, horrilysin, ruberlysin, bothropasin, oligopeptidase A, endothelin-converting enzyme, AD-AM10 endopeptidase and others.

Suitable enzymes acting on carbon-carbon bonds, which may be found in ketonic substances include, but are not limited to oxaloacetase, fumarylacetoacetase, kynureninase, phloretin hydrolase, acylpyruvate hydrolase, acetylpyruvate hydrolase, β-diketone hydrolase, 2,6-dioxo-6-phenylhexa-3-enoate hydrolase, 2-hydroxymuconate-semialdehyde hydrolase and cyclohexane-1,3-dione hydrolase.

Examples of enzymes within the group acting on halide bonds are alkylhalidase, 2-haloacid dehalogenase, haloacetate dehalogenase, thyroxine deiodinase, haloalkane dehalogenase, 4-chlorobenzoate dehalogenase, 4-chlorobenzoyl-CoA dehalogenase, atrazine chlorohydrolase and the like.

Further examples according to the present invention of enzymes acting on specific bonds are phosphoamidase, N-sulfoglucosamine sulfohydrolase, cyclamate sulfohydrolase, phosphonoacetaldehyde hydrolase, phosphonoacetate hydrolase, trithionate hydrolase, UDPsulfoquinovose synthase and the like.

According to the present invention enzymes added in biodegradable chewing gum may be of one type alone or different types in combination.

Some enzymes require co-factors to be effective. Examples of such co-factors are 5,10-methenyltetrahydrofolate, ammonia, ascorbate, ATP, bicarbonate, bile salts, biotin, bis(molybdopterin guanine dinucleotide)molybdenum cofactor, cadmium, calcium, cobalamin, cobalt, coenzyme F430, coenzyme-A, copper, dipyrromethane, dithiothreitol, divalent cation, FAD, flavin, flavoprotein, FMN, glutathione, heme, heme-thiolate, iron, iron(2+), iron-molybdenum, iron-sulfur, lipoyl group, magnesium, manganese, metal ions, molybdenum, molybdopterin, monovalent cation, NAD, NAD(P)H, nickel, potassium, PQQ, protoheme IX, pyridoxal-phosphate, pyruvate, selenium, siroheme, sodium, tetrahydropteridine, thiamine diphosphate, topaquinone, tryptophan tryptophylquinone (TTQ), tungsten, vanadium and zinc.

In accordance with the general principles in manufacturing an embodiment within the scope of the invention, variations of different suitable ingredients are listed and explained below.

The chewing gum according to the invention may comprise coloring agents. According to an embodiment of the invention, the chewing gum may comprise color agents and whiteners such as FD&C-type dyes and lakes, fruit and vegetable extracts, titanium dioxide and combinations thereof. Further useful chewing gum base components include antioxidants, e.g. butylated hydroxytoluene (BHT), butyl hydroxyanisol (BHA), propylgallate and tocopherols, and preservatives.

In an embodiment of the invention, the chewing gum comprises softeners in an amount of about 0 to about 18% by weight of the chewing gum, more typically about 0 to about 12% by weight of the chewing gum.

Softeners/emulsifiers may according to the invention be added both in the chewing gum and the gum base.

A gum base formulation may, in accordance with the present invention, comprise one or more softening agents e.g. sucrose polyesters including those disclosed in WO 00/25598, which is incorporated herein by reference, tallow, hydrogenated tallow, hydrogenated and partially hydrogenated vegetable oils, cocoa butter, degreased cocoa powder, glycerol monostearate, glycerol triacetate, lecithin, mono-, di- and triglycerides, acetylated monoglycerides, fatty acids (e.g. stearic, palmitic, oleic and linoleic acids) and combinations thereof. As used herein the term “softener” designates an ingredient, which softens the gum base or chewing gum formulation and encompasses waxes, fats, oils, emulsifiers, surfactants and solubilisers.

To soften the gum base further and to provide it with water-binding properties, which confer to the gum base a pleasant smooth surface and reduce its adhesive properties, one or more emulsifiers is/are usually added to the composition, typically in an amount of 0 to 18% by weight, preferably 0 to 12% by weight of the gum base. Mono- and diglycerides of edible fatty acids, lactic acid esters and acetic acid esters of mono- and diglycerides of edible fatty acids, acetylated mono and diglycerides, sugar esters of edible fatty acids, Na—, K—, Mg— and Ca-stearates, lecithin, hydroxylated lecithin and the like are examples of conventionally used emulsifiers which can be added to the chewing gum base. In case of the presence of a biologically or pharmaceutically active ingredient as defined below, the formulation may comprise certain specific emulsifiers and/or solubilisers in order to disperse and release the active ingredient.

Waxes and fats are conventionally used for the adjustment of the consistency and for softening of the chewing gum base when preparing chewing gum bases. In connection with the present invention, any conventionally used and suitable type of wax and fat may be used, such as for instance rice bran wax, polyethylene wax, petroleum wax (refined paraffin and microcrystalline wax), paraffin, beeswax, carnauba wax, candelilla wax, cocoa butter, degreased cocoa powder and any suitable oil or fat, as e.g. completely or partially hydrogenated vegetable oils or completely or partially hydrogenated animal fats.

In an embodiment of the invention, the chewing gum comprises filler.

A chewing gum base formulation may, if desired, include one or more fillers/texturisers including as examples, magnesium and calcium carbonate, sodium sulphate, ground limestone, silicate compounds such as magnesium and aluminum silicate, kaolin and clay, aluminum oxide, silicium oxide, talc, titanium oxide, mono-, di- and tri-calcium phosphates, cellulose polymers, such as wood, and combinations thereof.

In an embodiment of the invention, the chewing gum comprises filler in an amount of about 0 to about 50% by weight of the chewing gum, more typically about 10 to about 40% by weight of the chewing gum.

In the present context, chewing gum ingredients may for example comprise bulk sweeteners, high-intensity sweeteners, flavoring agents, softeners, emulsifiers, coloring agents, binding agents, acidulants, fillers, antioxidants and other components such as pharmaceutically or biologically active substances, conferring desired properties to the finished chewing gum product.

Suitable bulk sweeteners include both sugar and non-sugar sweetening components. Bulk sweeteners typically constitute from about 5 to about 95% by weight of the chewing gum, more typically about 20 to about 80% by weight such as 30 to 60% by weight of the gum.

Useful sugar sweeteners are saccharide-containing components commonly known in the chewing gum art including, but not limited to, sucrose, dextrose, maltose, dextrins, trehalose, D-tagatose, dried invert sugar, fructose, levulose, galactose, corn syrup solids, and the like, alone or in combination.

Sorbitol can be used as a non-sugar sweetener. Other useful non-sugar sweeteners include, but are not limited to, other sugar alcohols such as mannitol, xylitol, hydrogenated starch hydrolysates, maltitol, isomaltol, erythritol, lactitol and the like, alone or in combination.

High-intensity artificial sweetening agents can also be used alone or in combination with the above sweeteners. Preferred high-intensity sweeteners include, but are not limited to sucralose, aspartame, salts of acesulfame, alitame, saccharin and its salts, cyclamic acid and its salts, glycyrrhizin, dihydrochalcones, thaumatin, monellin, sterioside and the like, alone or in combination. In order to provide longer lasting sweetness and flavor perception, it may be desirable to encapsulate or otherwise control the release of at least a portion of the artificial sweetener. Techniques such as wet granulation, wax granulation, spray drying, spray chilling, fluid bed coating, coascervation, encapsulation in yeast cells and fiber extrusion may be used to achieve the desired release characteristics. Encapsulation of sweetening agents can also be provided using another chewing gum component such as a resinous compound.

Usage level of the artificial sweetener will vary considerably and will depend on factors such as potency of the sweetener, rate of release, desired sweetness of the product, level and type of flavor used and cost considerations. Thus, the active level of artificial sweetener may vary from about 0.02 to about 30% by weight, preferably 0.02 to about 8% per weight. When carriers used for encapsulation are included, the usage level of the encapsulated sweetener will be proportionately higher. Combinations of sugar and/or non-sugar sweeteners can be used in the chewing gum formulation processed in accordance with the invention. Additionally, the softener may also provide additional sweetness such as aqueous sugar or alditol solutions.

If a low-calorie gum is desired, a low-caloric bulking agent can be used. Examples of low caloric bulking agents include polydextrose, Raftilose, Raftilin, fructooligosaccharides (NutraFlora®), palatinose oligosaccharides; guar gum hydrolysates (e.g. Sun Fiber®) or indigestible dextrins (e.g. Fibersol®). However, other low-calorie bulking agents can be used.

The chewing gum according to the present invention may contain aroma agents and flavoring agents including natural and synthetic flavorings e.g. in the form of natural vegetable components, essential oils, essences, extracts, powders, including acids and other substances capable of affecting the taste profile. Examples of liquid and powdered flavorings include coconut, coffee, chocolate, vanilla, grape fruit, orange, lime, menthol, liquorice, caramel aroma, honey aroma, peanut, walnut, cashew, hazelnut, almonds, pineapple, strawberry, raspberry, tropical fruits, cherries, cinnamon, peppermint, wintergreen, spearmint, eucalyptus, and mint, fruit essence such as from apple, pear, peach, strawberry, apricot, raspberry, cherry, pineapple, and plum essence. The essential oils include peppermint, spearmint, menthol, eucalyptus, clove oil, bay oil, anise, thyme, cedar leaf oil, nutmeg, and oils of the fruits mentioned above.

The chewing gum flavor may be a natural flavoring agent, which is freeze-dried, preferably in the form of a powder, slices or pieces or combinations thereof. The particle size may be less than 3 mm, less than 2 mm or more preferred less than 1 mm, calculated as the longest dimension of the particle. The natural flavoring agent may in a form where the particle size is from about 3 μm to 2 mm, such as from 4 μm to 1 mm. Preferred natural flavoring agents include seeds from fruit e.g. from strawberry, blackberry and raspberry.

Various synthetic flavors, such as mixed fruit flavors may also be used in the present chewing gum centers. As indicated above, the aroma agent may be used in quantities smaller than those conventionally used. The aroma agents and/or flavors may be used in the amount from 0.01 to about 30% by weight of the final product depending on the desired intensity of the aroma and/or flavor used. Preferably, the content of aroma/flavor is in the range of 0.2 to 3% by weight of the total composition.

In an embodiment of the invention, the flavoring agents comprise natural and synthetic flavorings in the form of natural vegetable components, essential oils, essences, extracts, powders, including acids and other substances capable of affecting the taste profile.

Further chewing gum ingredients, which may be included in the chewing gum according to the present invention, include surfactants and/or solubilisers, especially when pharmaceutically or biologically active ingredients are present. As examples of types of surfactants to be used as solubilisers in a chewing gum composition according to the invention, reference is made to H. P. Fiedler, Lexikon der Hilfstoffe für Pharmacie, Kosmetik und Angrenzende Gebiete, pages 63-64 (1981) and the lists of approved food emulsifiers of the individual countries. Anionic, cationic, amphoteric or non-ionic solubilisers can be used. Suitable solubilisers include lecithin, polyoxyethylene stearate, polyoxyethylene sorbitan fatty acid esters, fatty acid salts, mono and diacetyl tartaric acid esters of mono and diglycerides of edible fatty acids, citric acid esters of mono and diglycerides of edible fatty acids, saccharose esters of fatty acids, polyglycerol esters of fatty acids, polyglycerol esters of interesterified castor oil acid (E476), sodium stearoyllatylate, sodium lauryl sulfate and sorbitan esters of fatty acids and polyoxyethylated hydrogenated castor oil (e.g. the product sold under the trade name CREMOPHOR), block copolymers of ethylene oxide and propylene oxide (e.g. products sold under trade names PLURONIC and POLOXAMER), polyoxyethylene fatty alcohol ethers, polyoxyethylene sorbitan fatty acid esters, sorbitan esters of fatty acids and polyoxyethylene stearic acid esters.

Particularly suitable solubilisers are polyoxyethylene stearates, such as for instance polyoxyethylene(8)stearate and polyoxyethylene(40)stearate, the polyoxyethylene sorbitan fatty acid esters sold under the trade name TWEEN, for instance TWEEN 20 (monolaurate), TWEEN 80 (monooleate), TWEEN 40 (monopalmitate), TWEEN 60 (monostearate) or TWEEN 65 (tristearate), mono and diacetyl tartaric acid esters of mono and diglycerides of edible fatty acids, citric acid esters of mono and diglycerides of edible fatty acids, sodium stearoyllatylate, sodium laurylsulfate, polyoxyethylated hydrogenated castor oil, blockcopolymers of ethylene oxide and propyleneoxide and polyoxyethylene fatty alcohol ether. The solubiliser may either be a single compound or a combination of several compounds. In the presence of an active ingredient, the chewing gum may preferably also comprise a carrier known in the art.

In one embodiment the chewing gum according to the invention comprises a pharmaceutically, cosmetically or biologically active substance. Examples of such active substances, a comprehensive list of which is found e.g. in WO 00/25598, which is incorporated herein by reference, include drugs, dietary supplements, antiseptic agents, pH-adjusting agents, anti-smoking agents and substances for the care or treatment of the oral cavity and teeth such as hydrogen peroxide and compounds capable of releasing urea during chewing. Examples of useful active substances in the form of antiseptics include salts and derivatives of guanidine and biguanidine (for instance chlorhexidine diacetate) and the following types of substances with limited water-solubility: quaternary ammonium compounds (e.g. ceramine, chloroxylenol, crystal violet, chloramine), aldehydes (e.g. paraformaldehyde), derivatives of dequaline, polynoxyline, phenols (e.g. thymol, p-chlorophenol, cresol), hexachlorophene, salicylic anilide compounds, triclosan, halogenes (iodine, iodophores, chloroamine, dichlorocyanuric acid salts), alcohols (3,4dichlorobenzyl alcohol, benzyl alcohol, phenoxyethanol, phenylethanol), cf. also Martindale, The Extra Pharmacopoeia, 28th edition, pages 547-578; metal salts, complexes and compounds with limited water-solubility, such as aluminum salts, (for instance aluminum potassium sulphate AlK(SO₄)₂,12H₂O) and salts, complexes and compounds of boron, barium, strontium, iron, calcium, zinc, (zinc acetate, zinc chloride, zinc gluconate), copper (copper chloride, copper sulphate), lead, silver, magnesium, sodium, potassium, lithium, molybdenum, vanadium should be included; other compositions for the care of mouth and teeth: for instance salts, complexes and compounds containing fluorine (such as sodium fluoride, sodium monofluorophosphate, aminofluorides, stannous fluoride), phosphates, carbonates and selenium. Further active substances can be found in J. Dent. Res. Vol. 28 No. 2, pages 160-171,1949.

Examples of active substances in the form of agents adjusting the pH in the oral cavity include: acids, such as adipinic acid, succinic acid, fumaric acid, or salts thereof or salts of citric acid, tartaric acid, malic acid, acetic acid, lactic acid, phosphoric acid and glutaric acid and acceptable bases, such as carbonates, hydrogen carbonates, phosphates, sulphates or oxides of sodium, potassium, ammonium, magnesium or calcium, especially magnesium and calcium.

Active ingredients may comprise the below-mentioned compounds or derivates thereof but are not limited thereto: Acetaminophen, Acetylsalicylsyre Buprenorphine Bromhexin Celcoxib Codeine, Diphenhydramin, Diclofenac, Etoricoxib, Ibuprofen, Indometacin, Ketoprofen, Lumiracoxib, Morphine, Naproxen, Oxycodon, Parecoxib, Piroxicam, Pseudoefedrin, Rofecoxib, Tenoxicam, Tramadol, Valdecoxib, Calciumcarbonat, Magaldrate, Disulfiram, Bupropion, Nicotine, Azithromycin, Clarithromycin, Clotrimazole, Erythromycin, Tetracycline, Granisetron, Ondansetron, Prometazin, Tropisetron, Brompheniramine, Ceterizin, leco-Ceterizin, Chlorcyclizine, Chlorpheniramin, Chlorpheniramin, Difenhydramine, Doxylamine, Fenofenadin, Guaifenesin, Loratidin, des-Loratidin, Phenyltoloxamine, Promethazin, Pyridamine, Terfenadin, Troxerutin, Methyldopa, Methylphenidate, Benzalcon. Chloride, Benzeth. Chloride, Cetylpyrid. Chloride, Chlorhexidine, Ecabet-sodium, Haloperidol, Allopurinol, Colchinine, Theophylline, Propanolol, Prednisolone, Prednisone, Fluoride, Urea, Miconazole, Actot, Glibenclamide, Glipizide, Metformin, Miglitol, Repaglinide, Rosiglitazone, Apomorfin, Cialis, Sildenafil, Vardenafil, Diphenoxylate, Simethicone, Cimetidine, Famotidine, Ranitidine, Ratinidine, cetrizin, Loratadine, Aspirin, Benzocaine, Dextrometorphan, Ephedrine, Phenylpropanolamine, Pseudoephedrine, Cisapride, Domperidone, Metoclopramide, Acyclovir, Dioctylsulfosucc., Phenolphtalein, Almotriptan, Eletriptan, Ergotamine, Migea, Naratriptan, Rizatriptan, Sumatriptan, Zolmitriptan, Aluminum salts, Calcium salts, Ferro salts, Silver salts, Zinc-salts, Amphotericin B, Chlorhexidine, Miconazole, Triamcinolonacetonid, Melatonine, Phenobarbitol, Caffeine, Benzodiazepiner, Hydroxyzine, Meprobamate, Phenothiazine, Buclizine, Brometazine, Cinnarizine, Cyclizine, Difenhydramine, Dimenhydrinate, Buflomedil, Amphetamine, Caffeine, Ephedrine, Orlistat, Phenylephedrine, Phenylpropanolamin, Pseudoephedrine, Sibutramin, Ketoconazole, Nitroglycerin, Nystatin, Progesterone, Testosterone, Vitamin B12, Vitamin C, Vitamin A, Vitamin D, Vitamin E, Pilocarpin, Aluminumaminoacetat, Cimetidine, Esomeprazole, Famotidine, Lansoprazole, Magnesiumoxide, Nizatide and or Ratinidine.

Generally, it is preferred that the chewing gum and the gum bases prepared according to the invention are based solely on biodegradable polymers. However, within the scope of the invention further conventional chewing gum elastomers or elastomer plasticizers may be applied. Thus, in an embodiment of the invention, the at least one biodegradable polymer comprises from at least 5% to at least 90% of the chewing gum polymers and where the rest of the polymers comprise polymers generally regarded as non-biodegradable, such as natural resins, synthetic resins and/or synthetic elastomers.

In an embodiment of the invention, said natural resin comprises terpene resins, e.g. derived from alpha-pinene, beta-pinene, and/or d-limonene, natural terpene resins, glycerol esters of gum rosins, tall oil rosins, wood rosins or other derivatives thereof such as glycerol esters of partially hydrogenated rosins, glycerol esters of polymerized rosins, glycerol esters of partially dimerised rosins, pentaerythritol esters of partially hydrogenated rosins, methyl esters of rosins, partially hydrogenated methyl esters of rosins or pentaerythritol esters of rosins and combinations thereof.

In an embodiment of the invention, said synthetic resin comprises polyvinyl acetate, vinyl acetate-vinyl laurate copolymers and mixtures thereof.

Generally within the scope of the invention, useful synthetic elastomers include, but are not limited to, synthetic elastomers listed in Food and Drug Administration, CFR, Title 21, Section 172,615, the Masticatory Substances, Synthetic) such as polyisobutylene. e.g. having a gas pressure chromatography (GPC) average molecular weight in the range of about 10,000 to 1,000,000 including the range of 50,000 to 80,000, isobutylene-isoprene copolymer (butyl elastomer), styrene-butadiene copolymers e.g. having styrene-butadiene ratios of about 1:3 to 3:1, polyvinyl acetate (PVA), e.g. having a GPC average molecular weight in the range of 2,000 to 90,000 such as the range of 3,000 to 80,000 including the range of 30,000 to 50,000, where the higher molecular weight polyvinyl acetates are typically used in bubble gum base, polyisoprene, polyethylene, vinyl acetate-vinyl laurate copolymer e.g. having a vinyl laurate content of about 5 to 50% by weight such as 10 to 45% by weight of the copolymer, and combinations hereof.

It is common in the industry to combine in a gum base a synthetic elastomer having a high molecular weight and a low molecular weight elastomer. Presently preferred combinations of synthetic elastomers include, but are not limited to, polyisobutylene and styrene-butadiene, polyisobutylene and polyisoprene, polyisobutylene and isobutylene-isoprene copolymer (butyl rubber) and a combination of polyisobutylene, styrene-butadiene copolymer and isobutylene isoprene copolymer, and all of the above individual synthetic polymers in admixture with polyvinyl acetate, vinyl acetate-vinyl laurate copolymers, respectively and mixtures thereof.

In accordance with the invention, the chewing gum base components, which are used herein, may include one or more resinous compounds contributing to obtain the desired masticatory properties and acting as plasticizers for the elastomers of the gum base composition. In the present context, useful elastomer plasticizers include, but are not limited to, natural rosin esters, often referred to as ester gums including as examples glycerol esters of partially hydrogenated rosins, glycerol esters of polymerised rosins, glycerol esters of partially dimerised rosins, glycerol esters of tally oil rosins, pentaerythritol esters of partially hydrogenated rosins, methyl esters of rosins, partially hydrogenated methyl esters of rosins and pentaerythritol esters of rosins. Other useful resinous compounds include synthetic resins such as terpene resins derived from alpha-pinene, beta-pinene, and/or d-limonene, natural terpene resins; and any suitable combinations of the foregoing. The choice of elastomer plasticizers will vary depending on the specific application, and on the type of elastomer(s) being used.

The chewing gum according to the invention may be provided with an outer coating. The applicable hard coating may be selected from the group comprising of sugar coating and a sugarless coating and a combination thereof. The hard coating may e.g. comprise 50 to 100% by weight of a polyol selected from the group consisting of sorbitol, maltitol, mannitol, xylitol, erythritol, lactitol and Isomalt and variations thereof. In an embodiment of the invention, the outer coating is an edible film comprising at least one component selected from the group consisting of an edible film-forming agent and a wax. The film-forming agent may e.g. be selected from the group comprising cellulose derivative, a modified starch, a dextrin, gelatine, shellac, gum arabic, zein, a vegetable gum, a synthetic polymer and any combination thereof. In an embodiment of the invention, the outer coating comprises at least one additive component selected from the group comprising of a binding agent, a moisture-absorbing component, a film-forming agent, a dispersing agent, an antisticking component, a bulking agent, a flavoring agent, a coloring agent, a pharmaceutically or cosmetically active component, a lipid component, a wax component, a sugar, an acid and an agent capable of accelerating the after-chewing degradation of the degradable polymer.

In a further embodiment of the invention, the outer coating is a soft coating. The soft coating may comprise sugar free coating agent.

Unless otherwise indicated, as used herein with regard to polymers, the term “molecular weight” means number average molecular weight (Mn) in g/mol. The short form PD designates the polydispersity. Likewise the molecular weight of enzymes is given in kilodaltons, abbreviated kDa.

The glass transition temperature (T_{g}) may be determined by for example DSC (DSC: differential scanning calorimetry). The DSC may generally be applied for determining and studying of the thermal transitions of a polymer and specifically, the technique may be applied for the determination of a second order transition of a material, i.e. a thermal transition that involves a change in heat capacity, but does not have a latent heat. The glass transition is a second-order transition.

The following non-limiting examples illustrate the manufacturing of a chewing gum according to the invention.

### EXAMPLE 1

Preparation of Polyester Elastomer Obtained by Ring-Opening Polymerization

An elastomer sample is synthesized within a dry N₂ glove box, as follows. Into a 500 mL resin kettle equipped with overhead mechanical stirrer, 3.143 g pentaerythritol and 0.5752 g Sn(Oct)₂ (2.0 ml of a 1.442 gSn(Oct) ⅖ mL in methylene chloride) are charged under dry N₂ gas purge. The methylene chloride is allowed to evaporate under the N₂ purge for 15 min. Then s-caprolactone (1144 g, 10 mol), Trimethylene carbonate (31 g, 0.30 mol) and 6-valerolactone (509 g, 5.1 mol) are added. The resin kettle is submerged in a 130° C. constant temperature oil bath and stirred for 13.9 h. Subsequently the kettle is removed from the oil bath and allowed to cool at room temperature. The solid, elastic product is removed in small pieces using a knife, and placed into a plastic container.

Characterization of the product indicates Mₙ=56,000 g/mol and M_{w}=98,700 g/mol (gel permeation chromatography with online MALLS detector). And Tg=−58.9° C. (DSC, heating rate 10° C./min).

### EXAMPLE 2

Preparation of Polyester Elastomer Obtained by Ring-Opening Polymerization

An elastomer sample is synthesized within a dry N₂ glove box, as follows. Into a 500 mL resin kettle equipped with overhead mechanical stirrer, 3.152 g pentaerythritol and 0.5768 g Sn(Oct)₂ (2.0 ml of a 1.442 gSn(Oct) ⅖ mL in methylene chloride) are charged under dry N₂ gas purge. The methylene chloride is allowed to evaporate under the N₂ purge for 15 min. Then ε-caprolactone (1148 g, 10 mol), Trimethylene carbonate (31 g, 0.30 mol) and 6-valerolactone (511 g, 5.1 mol) are added. The resin kettle is submerged in a 130° C. constant temperature oil bath and stirred for 13.4 h. Subsequently the kettle is removed from the oil bath and allowed to cool at room temperature. The solid, elastic product is removed in small pieces using a knife, and placed into a plastic container.

Characterization of the product indicates Mₙ=88,800 g/mol and M_{w}=297,000 g/mol (gel permeation chromatography with online MALLS detector). And Tg=−59.4° C. (DSC, heating rate 10° C./min).

### EXAMPLE 3

Preparation of Polyester Resin Obtained by Ring-Opening Polymerization

A resin sample is produced using a cylindrical glass, jacketed 10 L pilot reactor equipped with glass stir shaft and Teflon stir blades and bottom outlet. Heating of the reactor contents is accomplished by circulation of silicone oil, thermo stated to 130° C., through the outer jacket. ε-caprolactone (358.87 g, 3.145 mol) and 1,2-propylene glycol (79.87 g, 1.050 mol) are charged to the reactor together with stannous octoate (1.79 g, 4.42×10⁻³ mol) as the catalyst and reacting in about 30 min. at 130° C. Then molten D,L-lactide (4.877 kg, 33.84 mol) are added and reaction continued for about 2 hours. At the end of this period, the bottom outlet is opened, and molten polymer is allowed to drain into a Teflon-lined paint can.

Characterization of the product indicates Mₙ=6,000 g/mol and M_{w}=7,000 g/mol (gel permeation chromatography with online MALLS detector) and Tg=25-30° C. (DSC, heating rate 10° C./min).

### EXAMPLE 4

Preparation of Polyester Elastomer Obtained by Step-Growth Polymerization

An elastomer sample is produced using a 500 mL resin kettle equipped with an overhead stirrer, nitrogen gas inlet tube, thermometer, and distillation head for removal of methanol. To the kettle are charged 83.50 g (0.43 mole) dimethyl terephthalate, 99.29 g (0.57 mole) dimethyl adipate, 106.60 g (1.005 mole) di(ethylene glycol) and 0.6 g calcium acetate monohydrate. Under nitrogen, the mixture is slowly heated with stirring until all components become molten (120-140° C.). Heating and stirring are continued and methanol is continuously distilled. The temperature slowly rises in the range 150-200° C. until the evolution of methanol ceases. Heating is discontinued and the content is allowed to cool to about 100° C. The reactor lid is removed and the molten polymer is carefully poured into a receiving vessel.

Characterization of the product indicates Mₙ=40,000 g/mol and M_{w}=190,000 g/mol (gel permeation chromatography with online MALLS detector) and T_{g}=−30° C. (DSC, heating rate 10° C./min).

### EXAMPLE 5

Preparation of Gum Bases

The process of preparing gum bases is carried out in the following way: The elastomer and resin are added to a mixing kettle provided with mixing means like e.g. horizontally placed Z-shaped arms. The kettle has been preheated for 15 minutes to a temperature of about 60-80° C. The mixture is mixed for 10-20 minutes until the whole mixture becomes homogeneous. The mixture is then discharged into the pan and allowed to cool to room temperature from the discharged temperature of 60-80° C.

Two different gum bases as shown in table 1 were prepared.

TABLE 1
Gum base preparation.

| Gum | | | | Ratio of resin/ |
|---|---|---|---|---|
| base | | | | elastomer1/ |
| No. | Resin | Elastomer1 | Elastomer2 | elastomer2 |
| 101 | Resin polymer | Elastomer | Elastomer | 55/30/15 |
| | of example 3 | polymer of | polymer of | |
| | | example 1 | example 2 | |
| 102 | Resin polymer | Elastomer | — | 60/40 |
| | of example 3 | polymer of | | |
| | | example 4 | | |

### EXAMPLE 6

Preparation of Chewing Gum

The gum bases of example 5 were used in the preparation of chewing gum with the basic formulations shown in table 2. The formulations are identical with the exception that adding of enzyme substitutes sorbitol in equivalent amounts.

TABLE 2
Chewing gum formulations with different enzyme
concentrations. Peppermint flavor. Ingredients
concentrations are given in percent by weight.

| | Formulation No. | | | | | |
|---|---|---|---|---|---|---|
| Ingredients | 1000 | 1001 | 1002 | 1003 | 1004 | 1005 |
| Enzyme | 0.0 | 0.32 | 0.8 | 1.6 | 4.8 | 14.4 |
| Sorbitol | 44.6 | 44.28 | 43.8 | 43.0 | 39.8 | 30.2 |
| Gum base | 32.0 | 32.0 | 32.0 | 32.0 | 32.0 | 32.0 |
| Lycasin | 3.0 | 3.0 | 3.0 | 3.0 | 3.0 | 3.0 |
| Peppermint oil | 1.5 | 1.5 | 1.5 | 1.5 | 1.5 | 1.5 |
| Menthol crystals | 0.5 | 0.5 | 0.5 | 0.5 | 0.5 | 0.5 |
| Aspartame | 0.2 | 0.2 | 0.2 | 0.2 | 0.2 | 0.2 |
| Acesulfame | 0.2 | 0.2 | 0.2 | 0.2 | 0.2 | 0.2 |
| Xylitol | 6.0 | 6.0 | 6.0 | 6.0 | 6.0 | 6.0 |
| Wax | 4.0 | 4.0 | 4.0 | 4.0 | 4.0 | 4.0 |
| Triacetine | 2.0 | 2.0 | 2.0 | 2.0 | 2.0 | 2.0 |
| Emulsifiers | 1.0 | 1.0 | 1.0 | 1.0 | 1.0 | 1.0 |
| Talcum (Fillers) | 5.0 | 5.0 | 5.0 | 5.0 | 5.0 | 5.0 |

The enzyme concentrations 0.32, 0.8, 1.6, 4.8 and 14.4 which are weight percent of the total chewing gum formulation, correspond to 1.0, 2.5, 5.0, 15.0 and 45.0 percent related to the gum base content constituting 32 weight percent of the chewing gum.

The softeners, emulsifiers and fillers may alternatively be added to the polymers as a part of the gum base preparation.

The gum bases of example 5 were used with the chewing gum formulations of table 2 and the following chewing gum samples were prepared:

TABLE 3
Chewing gum samples with different gum bases,
enzyme concentrations and types of enzyme.

| | Gum | | Enzyme content | |
|---|---|---|---|---|
| Chewing | base | Formulation | related to gum | |
| gum No. | ref. | ref. | base content [%] | Enzyme |
| A | 101 | 1000 | 0 | — |
| B | 101 | 1001 | 1 | Trypsin |
| C | 101 | 1002 | 2.5 | Trypsin |
| D | 101 | 1003 | 5 | Trypsin |
| E | 101 | 1003 | 5 | Bromelain |
| F | 101 | 1003 | 5 | Neutrase |
| G | 101 | 1003 | 5 | Glucose oxidase |
| H | 101 | 1004 | 15 | Bromelain |
| I | 101 | 1004 | 15 | Neutrase |
| J | 101 | 1005 | 45 | Bromelain |
| K | 102 | 1000 | 0 | — |
| L | 102 | 1003 | 5 | Trypsin |
| M | 102 | 1004 | 15 | Bromelain |
| N | 102 | 1004 | 15 | Neutrase |

As it appears from table 3 each chewing gum sample was prepared with either none or one of four different enzymes, which were added in different amounts. The samples with no enzyme were prepared as references. The applied enzymes were purchased from companies located in Denmark: Antra ApS (Bromelain, product name Bromelin), Novozymes (Neutrase and Trypsin, product names Neutrase 0.8 L and Pancreatic Trypsin Novo 6.0 S, Type Saltfree) and Danisco Cultor (Glucose oxidase, product name TS-E 760). The enzymes Bromelain, Neutrase and Glucose oxidase were available as powders and the enzyme Trypsin as a liquid.

The chewing gum products are prepared as follows:

The gum base is added to a mixing kettle provided with mixing means like e.g. horizontally placed Z-shaped arms. The kettle has been preheated for 15 minutes to a temperature of about 60-80° C. or the chewing gum is made in one step, immediately after preparation of gum base in the same mixer where the gum base and kettle has a temperature of about 60-80° C.

One half portion of the sorbitol is added together with the gum base and mixed for 3 minutes. Peppermint and menthol are then added to the kettle and mixed for 1 minute. The remaining half portion of sorbitol is added and mixed for 1 minute. Softeners are slowly added and mixed for 7 minutes. Then aspartame and acesulfame are added to the kettle and mixed for 3 minutes. Xylitol is added and mixed for 3 minutes. Finally enzyme is added and mixing continues for 1-1½ minutes. After addition of enzyme, care should be taken not to exceed the temperature, which is tolerated by the applied type of enzyme. The resulting gum mixture is then discharged and e.g. transferred to a pan at a temperature of 40-48° C. The gum is then rolled and cut into cores, sticks, balls, cubes, and any other desired shape, optionally followed by coating and polishing processes prior to packaging or use. Evidently, within the scope of the invention, other processes and ingredients may be applied in the process of manufacturing the chewing gum, for instance the one-step method may be a lenient alternative.

### EXAMPLE 7

Degradation of Chewing Gum

Chewing gum products prepared according to example 5 were chewed in a mastication device (CF Jansson) and left for degradation in either air or phosphate buffer.

Corresponding unchewed chewing gum pieces were exposed to equivalent degradation. Both chewed and unchewed gum pieces were observed for a period of 10 days and the degradation was evaluated on the basis of visual rating and GC/MS-analysis.

The different types of chewing gum pieces according to table 3 were separately exposed to the following experimental setup, where only the points 4 to 6 applies for the unchewed gum pieces.
1. Placed in a mastication device containing 20 ml phosphate buffer solution (ammonium-di-hydrogen-phosphate 0.012 M adjusted to pH 7.4 with a 2 M NaOH solution).
2. Chewed for 5 minutes with a chewing frequency of 60 chews/min.
3. Removed from solution and formed into a spherical ball.
4. Placed in the center of a Petri dish—or placed in a closed glass containing 5 ml (0.012 M) phosphate buffer solution adjusted to pH 5.6.
5. The Petri dish placed at 30° C. at 70% relative humidity (RH)— or the glass containing buffer solution placed at 30° C.
6. Evaluated for degradation.
   Evaluation Procedures;
   Visual Evaluation:

The degradation of each chewing gum piece was rated on two scales, which are explained below. The visual evaluation was carried out after 3, 6 and 10 days.

Scale from 10 to 0 relating to the appearance of the chewing gum pieces in either air or buffer:
10: No noticable degradation.
9: Deviation from initial form; thus the chewing gum piece is slightly opened.
8: The chewing gum piece is even more open and it unfolds more. Also a beginning disintegration has occurred.
7: Beginning cracklement of the gum piece surface.
5: The chewing gum surface is very crackled.
1: The chewing gum piece is completely disintegrated and found in suspension.
0: The chewing gum piece is completely degraded.

Scale from P1 to P10 relating to the appearance of the buffer solution in which chewing gum pieces are placed:
P0: No change is visible in the solution.
P1: The solution appears clear, although a few small particles have occurred.
P3: The solution is relatively transparent, while containing several small flakes and/or a few larger “slimy” particles.
P6: The solution is very “slimy”, while number and size of the flakes have increased and the transparency of the solution has decreased.
P10: The solution contains the entire chewing gum piece in form of small particles.
   GC/MS Analysis:

The method used in the evaluation by GC/MS included headspace-sampling (Perkin Elmer Turbo Matrix 40), thus the chewing gum residues and the buffer solution after degradation were placed in vials wherein release of components to headspace were obtained. After a period of equilibration a sample of headspace-air was injected into the GC/MS-system (Perkin Elmer Clarus 500) and in the resulting chromatograms the areas of relevant peaks were evaluated whereby the effect of different treatments were compared as described in the following results section.

Visual Evaluation Results

The results of the visual evaluation of enzyme-containing chewing gum pieces (and reference gum piece without enzyme) left for degradation are given here below.

Regarding chewing gum left in air the change, which could be detected visually, was minor. After 10 days the unchewed gum pieces were generally given a degradation score of 10, whereas the chewed gum pieces were given a score of 9 for the reason that their spherical form was altered and a slight opening or unfolding could be observed. Regarding chewing gum left in buffer solution the enzyme effect was more pronounced. Both for chewed and unchewed gum, these experiments showed that including enzyme in chewing gum in some cases has an accelerating effect on the chewing gum degradation.

TABLE 4
Chewed gum degradation in buffer.

| | Chewed gum | | | | Chewed gum buffer | | |
|---|---|---|---|---|---|---|---|
| Chewing | Day | Day | Day | Chewing | Day | Day | Day |
| gum no. | 3 | 6 | 10 | gum no. | 3 | 6 | 10 |
| A | 9 | 9 | 9 | A | P0 | P0 | P0 |
| B | 8 | 8 | 8 | B | P0 | P1 | P1 |
| C | 8 | 8 | 8 | C | P0 | P1 | P1 |
| D | 9 | 8 | 8 | D | P0 | P1 | P4 |
| E | 8 | 8 | 8 | E | P0 | P0 | P0 |
| F | 9 | 8 | 8 | F | P0 | P1 | P2 |
| G | 8 | 8 | 8 | G | P0 | P0 | P0 |
| H | 8 | 8 | 8 | H | P0 | P1 | P2 |
| I | 8 | 8 | 8 | I | P1 | P1 | P2 |
| J | 8 | 8 | 7 | J | P1 | P2 | P3 |
| K | 8 | 8 | 8 | K | P0 | P1 | P1 |
| L | 8 | 8 | 8 | L | P1 | P5 | P6 |
| M | 7 | 7 | 6 | M | P1 | P4 | P4 |
| N | 6 | 6 | 5 | N | P1 | P2 | P3 |

TABLE 5
Unchewed gum degradation in buffer.

| | Unchewed gum | | | | Unchewed gum buffer | | |
|---|---|---|---|---|---|---|---|
| Chewing | Day | Day | Day | Chewing | Day | Day | Day |
| gum no. | 3 | 6 | 10 | gum no. | 3 | 6 | 10 |
| A | 10 | 10 | 10 | A | P0 | P0 | P0 |
| B | 10 | 10 | 10 | B | P0 | P0 | P1 |
| C | 10 | 10 | 10 | C | P0 | P0 | P1 |
| D | 10 | 10 | 10 | D | P0 | P0 | P2 |
| E | 10 | 10 | 10 | E | P0 | P0 | P0 |
| F | 10 | 10 | 10 | F | P0 | P1 | P2 |
| G | 10 | 9 | 9 | G | P0 | P0 | P3 |
| H | 10 | 10 | 10 | H | P0 | P2 | P2 |
| I | 9 | 9 | 9 | I | P1 | P2 | P3 |
| J | 10 | 10 | 10 | J | P0 | P2 | P2 |
| K | 10 | 10 | 9 | K | P0 | P2 | P2 |
| L | 10 | 9 | 8 | L | P1 | P2 | P2 |
| M | 10 | 9 | 8 | M | P1 | P3 | P3 |
| N | 8 | 7 | 5 | N | P1 | P1 | P2 |

It appears from tables 4 and 5 that addition of enzyme has accelerated the chewing gum degradation related to chewing gum without enzyme. Moreover, the effect of increasing the enzyme concentration is an increased degradation.

Chewing gum containing glucose oxidase behaved differently from the rest of the samples in that the enzymatic effect revealed different symptoms, which for chewed gum was a high degree of stickiness, while unchewed gum was shrinking.

Furthermore, it should be noted that there are differences in the visible degradation of chewing gum containing gum base 101 and 102, indicating that results of enzymatic influence are diverse and dependent on the type of polymers used. It is predictable that different gum bases react in different ways on the addition of enzymes and it is a matter of designing the appropriate combinations of polymers and enzymes, which give the optimal degradation. This may include both conventional polymers and polymers regarded as biodegradable.

In table 6 the results of measuring pH in the buffer solutions after 10 days are shown:

TABLE 6
pH in buffer solution after 10 days.

| Chewing gum no. | Chewed gum | Unchewed gum |
|---|---|---|
| A | 4.5 | 4.6 |
| B | 4.9 | 4.2 |
| C | 4.7 | 4.2 |
| D | 4.5 | 4.2 |
| E | 4.5 | 3.9 |
| F | 4.5 | 4.5 |
| G | 4.1 | 3.6 |
| H | 4.4 | 3.8 |
| I | 4.7 | 4.2 |
| J | 4.4 | 3.8 |
| K | 4.8 | 4.9 |
| L | 4.4 | 4.4 |
| M | 4.4 | 4.0 |
| N | 4.7 | 4.6 |

It appears from table 6 that despite the buffer, which was adjusted to pH 5.6, the pH has dropped in either solutions surrounding chewed or unchewed gum, indicating the occurrence of degradation.

GC/MS Evaluation Results

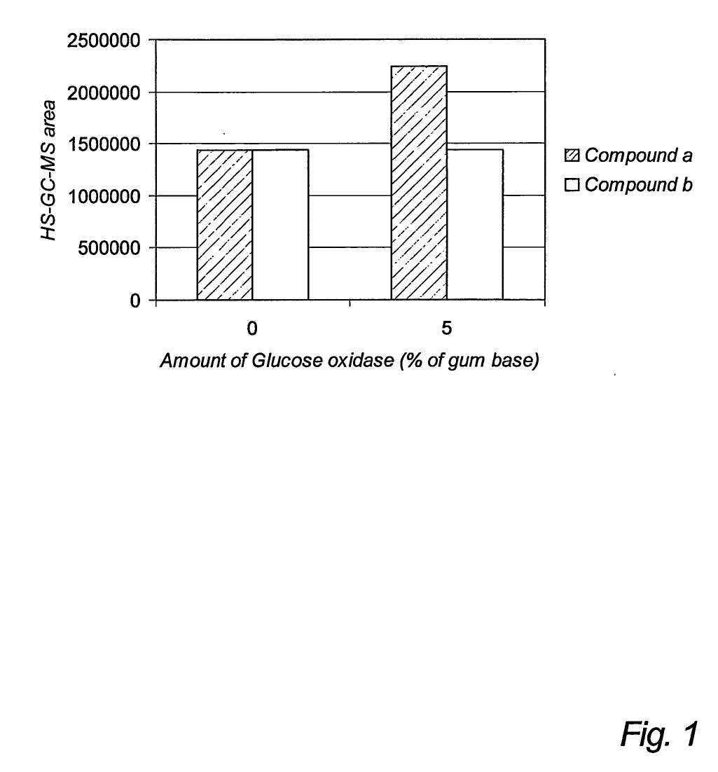

Results of the GC/MS-evaluation are presented in FIGS. 1 to 4, which are illustrating the formation of two different compounds resulting from chewing gum degradation. The figures are concerning the following chewing gum numbers:

FIG. 1 A and G,

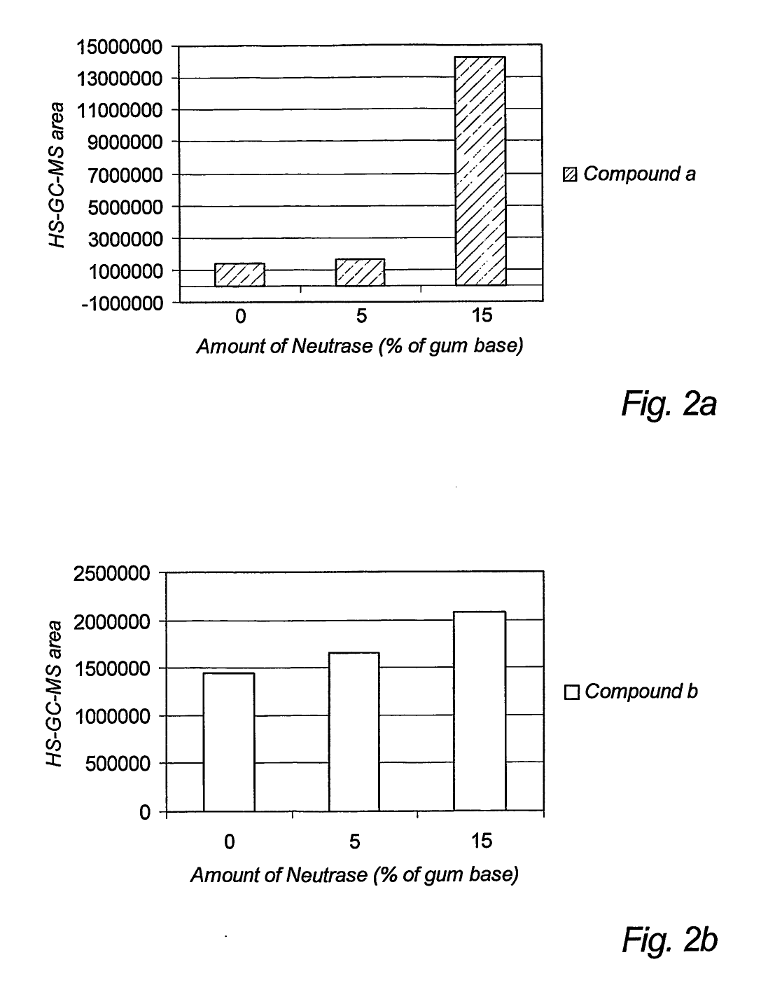

FIG. 2 A, F and I

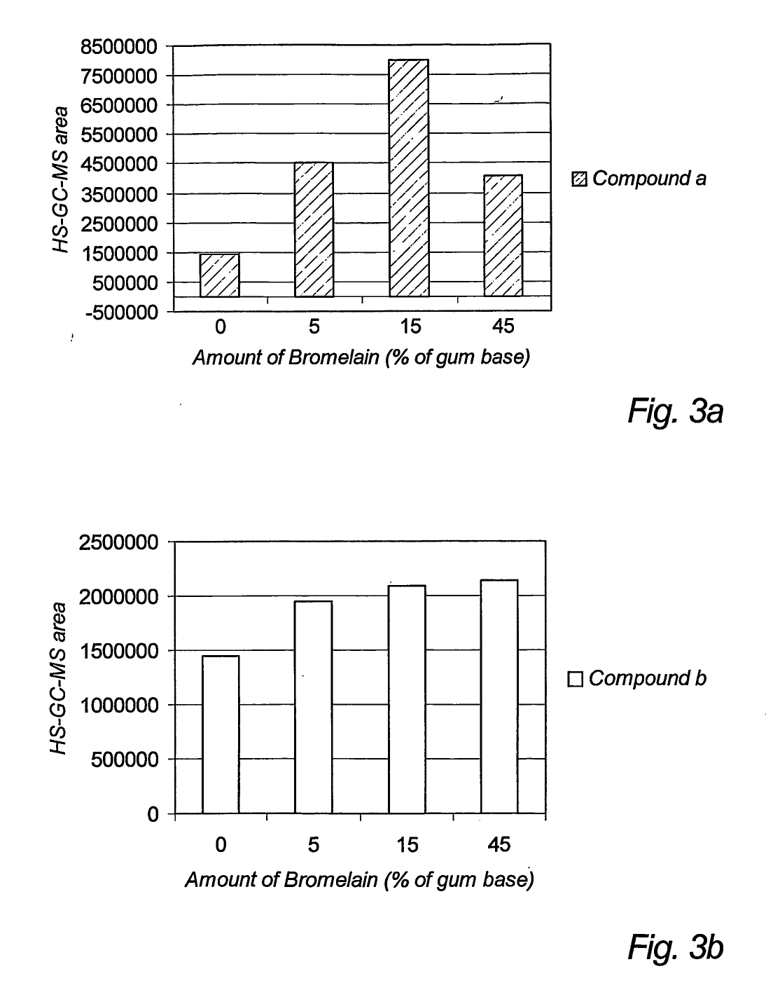

FIG. 3 A, E, H and J

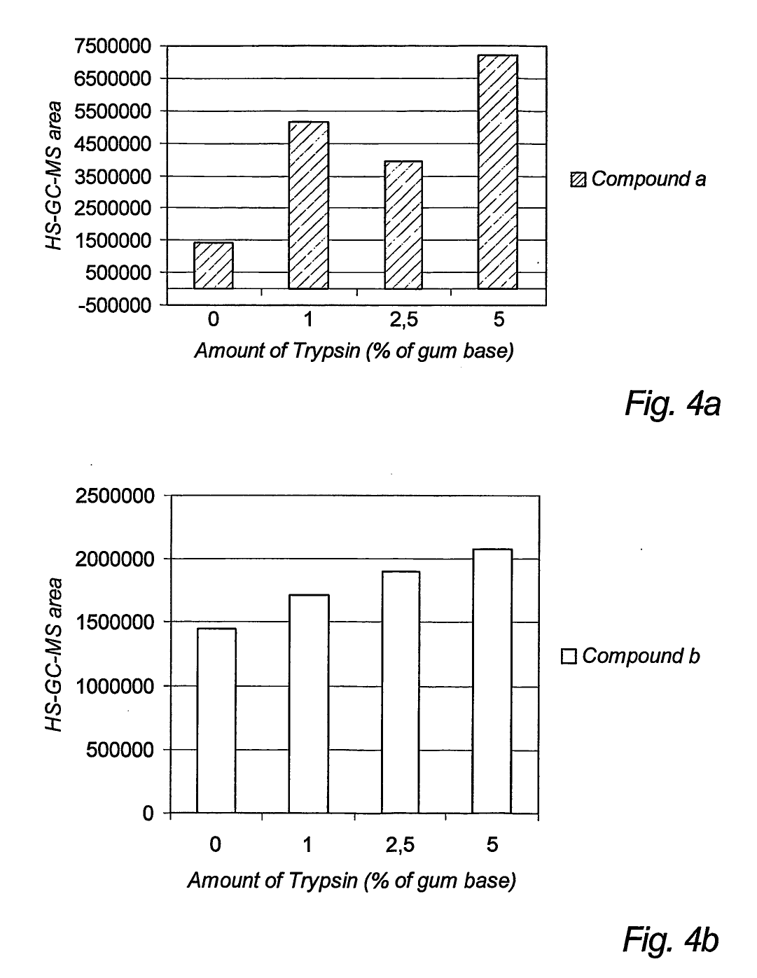

FIG. 4 A, B, C and D

In general the results are confirming the visual observations in that chewing gum containing enzymes are distinguished from chewing gum without enzymes by the appearance of larger amounts of degradation products.

FIG. 1 shows that one of the degradation products, compound a, has been formed in a larger amount as a result of the addition of an oxidoreductase enzyme, glucose oxidase.

FIGS. 2a and 2b show increased formation of both degradation products by increasing the amounts of added hydrolase enzyme, neutrase.

In FIG. 3a it appears that the degradation product, compound a, has been formed in increasing amounts by increasing bromelain enzyme content in the chewing gum. However at the largest enzyme content a smaller amount of degradation product has been formed. This could be the result of an overload of enzymes. It should be expected that enzymatic activity might be hindered at enzyme concentrations beyond a certain optimum concentration, which means that it is a matter of designing the appropriate relationship between polymer content and enzyme content in the chewing gum.

In FIG. 3b it appears that increase of bromelain enzyme concentration results in larger formation of the degradation product, compound b, however, the increase of degradation product between enzyme concentrations 15% and 45% is rather low. This again indicates that obtaining an accelerated degradation is a matter of providing a suitable level of enzyme concentration.

FIGS. 4a and 4b illustrate the tendency of increased enzymatic influence on degradation when the amount of trypsin enzyme concentration is increased in chewing gum, although the correlation is not categorically proportional.

Generally it is found that different types of enzymes may show the desired effect of degradation. In the present test both hydrolases and oxidoreductases influenced the degradation as catalysts, which could be observed both visually and by GC/MS.

Generally it is noted, that it is not unambiguously the case that higher enzyme concentration makes the degradation proceed faster. The relationship between polymer substrate and enzyme should be optimized.

1. Chewing gum comprising at least one polymer, chewing gum ingredients and enzymes, wherein at least one of said polymers forms a substrate for at least one of said enzymes.

2. Chewing gum according to claim 1,
wherein said chewing gum includes center filling.

3. Chewing gum according to claim 1,
wherein said chewing gum includes coating.

4. Chewing gum according to claim 1,
wherein said chewing gum ingredients comprise sweeteners and flavors.

5. Chewing gum according to claim 1,
wherein said chewing gum ingredients comprise softeners and further additives.

6. Chewing gum according to claim 1,
wherein said at least one polymer constitutes a chewing gum base.

7. Chewing gum according to claim 1,
wherein said at least one polymer comprises at least one copolymer.

8. Chewing gum according to claim 7,
wherein said at least one copolymer is polymerized of at least two different monomers, each comprising 1-99%.

9. Chewing gum according to claim 1,
wherein said at least one polymer comprises at least one biodegradable polymer.

10. Chewing gum according to claim 9,
wherein at least one of said at least one biodegradable polymer comprises at least one biodegradable elastomer.

11. Chewing gum according to claim 9,
wherein at least one of said at least one biodegradable polymer comprises at least one biodegradable elastomer plasticizer.

12. Chewing gum according to claim 9,
wherein at least one of said at least one biodegradable polymer comprises at least one polyester polymer obtained by polymerization of at least one cyclic ester.

13. Chewing gum according to claim 9,
wherein at least one of said at least one biodegradable polymer comprises at least one polyester polymer obtained by polymerization of at least one alcohol or derivative thereof and at least one acid or derivative thereof.

14. Chewing gum according to claim 9,
wherein at least one of said at least one biodegradable polymer comprises at least one polyester obtained by polymerization of at least one compound selected from the group of cyclic esters, alcohols or derivatives thereof and carboxylic acids or derivatives thereof.

15.-21. (canceled)

22. Chewing gum according to claim 1,
wherein at least one of said at least one polymer has amorphous regions.

23. Chewing gum according to claim 1,
wherein said at least one polymer is aliphatic.

24. Chewing gum according to claim 1,
wherein the molecular weight of said at least one polymer is within the range of 500-500000 g/mol Mn.

25.-31. (canceled)

32. Chewing gum according to claim 12,
wherein at least one of said enzymes is accelerating the degradation of said polyester obtained by ring-opening polymerization of at least one cyclic ester.

33. Chewing gum according to claim 13,
wherein at least one of said enzymes is accelerating the degradation of said polyester obtained by polymerization of at least one alcohol or derivative thereof and at least one acid or derivative thereof.

34. (canceled)

35. Chewing gum according to claim 1,
wherein the chewing gum has water content of less than 10 wt %.

36. (canceled)

37. Chewing gum according to claim 1,
wherein the chewing gum comprises filler in an amount of 0 to 80 wt %.

38. Chewing gum according to claim 1,
wherein the concentration of said enzymes is in the range of 0.0001 wt % to 50 wt % of the chewing gum.

39. Chewing gum according to claim 1,
wherein the concentration of said enzymes is in the range of 0.001 wt % to 10 wt % of the chewing gum.

40. Chewing gum according to claim 1,
wherein the concentration of said enzymes is in the range of 0.01 wt % to 5 wt % of the chewing gum.

41. Chewing gum according to claim 1,
wherein the amount of said enzymes is in the range of 0.0001 to 80 wt % related to the amount of gum base in the chewing gum.

42. Chewing gum according to claim 1,
wherein the amount of said enzymes is in the range of 0.001 to 40 wt % related to the amount of gum base in the chewing gum.

43. Chewing gum according to claim 1,
wherein the amount of said enzymes is in the range of 0.1 to 20 wt % related to the amount of gum base in the chewing gum.

44. Chewing gum according to claim 1,
wherein at least one of said enzymes is selected from the group consisting of oxidoreductases, transferases, hydrolases, lyases, isomerases and ligases.

45.-55. (canceled)

56. Chewing gum according to claim 1,
wherein at least one of said enzymes is selected from the group of lipases, esterases, depolymerases, peptidases and proteases.

57. Chewing gum according to claim 1,
wherein at least one of said enzymes is an endo-enzyme.

58. Chewing gum according to claim 1,
wherein at least one of said enzymes is an exo-enzyme.

59. Chewing gum according to claim 1,
wherein at least one of said enzymes has a molecular weight of 2 to 1000 kDa.

60. Chewing gum according to claim 1,
wherein at least two of said enzymes are combined.

61. Chewing gum according to claim 1,
wherein at least one of said enzymes requires a co-factor to carry out its catalyzing function.

62. Chewing gum according to claim 1,
wherein at least one of said enzymes is incorporated in the chewing gum.

63. Chewing gum according to claim 1,
wherein at least one of said enzymes is incorporated in a gum base.

64. (canceled)

65. Chewing gum according to claim 1,
wherein at least one of said enzymes has optimum activity in the pH range from 1.0 to 11.0.

66. Chewing gum according to claim 1,
wherein at least one of said enzymes has optimum activity at temperatures in the range of −10 to 60° C.

67. Chewing gum according to claim 1,
wherein at least one of said enzymes has optimum activity in relative humidity conditions in the range of 10 to 100% RH.

68.-70. (canceled)

71. Chewing gum according to claim 1,
wherein said chewing gum is compressed and prepared by use of compression techniques.

72. Use of at least one enzyme for degradation of biodegradable chewing gum.

73. Use of at least one enzyme according to claim 72,
wherein said at least one enzyme comprises hydrolases.

74.-75. (canceled)
